(19) United States
(12) Patent Application Publication
(10) Pub. No.: US 2026/0046003 A1
(43) Pub. Date: Feb. 12, 2026

(54) METHOD FOR NETWORK-SIDED INFERENCE OF BEAM PAIR PREDICTION USING UPLINK REFERENCE SIGNALING (UL-RS)

(71) Applicant: Telefonaktiebolaget LM Ericsson (publ), Stockholm (SE)

(72) Inventors: Jingya LI, Göteborg (SE); Andreas NILSSON, Göteborg (SE); Icaro Leonardo DA SILVA, Solna (SE); Chunhui LI, Yokohama, Kanagawa (JP); Yufei BLANKENSHIP, Kildeer, IL (US); Henrik RYDÉN, Stockholm (SE)

(21) Appl. No.: 19/101,417

(22) PCT Filed: Aug. 11, 2023
(86) PCT No.: PCT/SE2023/050813

§ 371 Date: Feb. 5, 2025

Related U.S. Application Data
(60) Provisional application No. 63/397,419, filed on Aug. 12, 2022.
(60) Provisional application No. 63/397,511, filed on Aug. 12, 2022.

(51) Int. Cl. H04B 7/06; H04L 5/00

(52) U.S. Cl. CPC H04B 7/06952; H04L 5/0044

(57) ABSTRACT

A method, system and apparatus for network-sided inference of beam pair prediction using uplink reference signaling (UL-RS) are disclosed. According to one aspect, a method in a wireless device (WD) includes determining a mapping between M beams corresponding to M spatial filters of the WD and M beam identifications (IDs), M being an integer greater than zero. The method also includes receiving a configuration of uplink reference signals. The method further includes transmitting N uplink reference signals of the received configuration in N beams of the M beams, N being an integer not greater than M.

### TECHNICAL FIELD

The present disclosure relates to wireless communications, and in particular, to sounding reference signal (SRS)-based collection to support beam pair prediction model training and network-sided inference of beam pair prediction using uplink reference signaling (UL-RS).

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WDs), as well as communication between network nodes and between wireless devices. Sixth Generation (6G) wireless communication systems are also under development.

### SRS

In NR, a Sounding Reference Signal (SRS) is used for providing Channel State Information (CSI) to the network node (e.g., gNB) in the uplink (UL). The usage of SRS includes, e.g., deriving the appropriate transmission/reception beams and/or performing link adaptation (i.e., setting the transmission rank and the modulation and coding scheme (MCS)), and for selecting downlink (DL) (e.g., for Physical Downlink Shared Channel (PDSCH) transmissions) and UL (e.g., for Physical Uplink Shared Channel (PUSCH) transmissions) Multiple-Input-Multiple-Output (MIMO) precoding.

In LTE and NR, the SRS is configured via Radio Resource Control (RRC), where parts of the configuration may be updated (for reduced latency) through Medium Access Control (MAC) Control Element (CE) (MAC-CE) signaling. The configuration includes, for example, the SRS resource allocation (the physical mapping and the sequence to use) as well as the time-domain behavior (aperiodic, semi-persistent, or periodic). For aperiodic SRS transmission, the RRC configuration does not activate an SRS transmission from the wireless device, but instead, a dynamic activation trigger may be transmitted from the network node in the DL, via the Downlink Control Information (DCI) in the Physical Downlink Control Channel (PDCCH) which instructs the wireless device to transmit the SRS once, at a predetermined time.

When configuring SRS transmissions, the network node configures, through the SRS-Config IE, a set of SRS resources and a set of SRS resource sets, where each SRS resource set contains one or more SRS resources.

### SRS Configuration

In some existing systems, each SRS resource may be configured with the following in RRC. For example, 3GPP Technical Standard (TS) 38.331 version 16.1.0 provides the following:

| | |
|---|---|
| “SRS-Resource ::= | SEQUENCE { |
| srs-ResourceId | SRS-ResourceId, |
| nrofSRS-Ports | ENUMERATED {port1, ports2, ports4}, |
| ptrs-PortIndex | ENUMERATED {n0, n1 } |

OPTIONAL, -- Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
      }
    },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, |

groupHopping, sequenceHopping },

| | |
|---|---|
| resourceType | CHOICE { |
| aperiodic | SEQUENCE { |

```
        ...
      },
```

| | |
|---|---|
| semi-persistent | SEQUENCE { |
| periodicityAndOffset-sp | SRS-PeriodicityAndOffset, |

```
        ...
      },
```

| | |
|---|---|
| periodic | SEQUENCE { |
| periodicityAndOffset-p | SRS-PeriodicityAndOffset, |

```
        ...
      }
    },
```

| sequenceId | INTEGER (0..1023), | |
|---|---|---|
| spatialRelationInfo | SRS-SpatialRelationInfo | OPTIONAL, - |

```
- Need R
    ...,
    [[
```

| | |
|---|---|
| resourceMapping-r16 | SEQUENCE { |
| startPosition-r16 | INTEGER (0..13), |
| nrofSymbols-r16 | ENUMERATED {n1, n2, n4}, |
| repetitionFactor-r16 | ENUMERATED {n1, n2, n4} |

}

OPTIONAL -- Need R

```
    ]]
  }”
```

In some existing systems, for example, an SRS resource may be configurable with respect to, e.g.:
The number of SRS ports (1, 2, or 4), configured by the RRC parameter nrofSRS-Ports;
The transmission comb (i.e., mapping to every 2nd or 4th subcarrier), configured by the RRC parameter transmissionComb, which includes:
   The comb offset, configured by the RRC parameter combOffset, is specified (i.e., which of the combs that should be used);
   The cyclic shift, configured by the RRC parameter cyclicShift, that configures a (port-specific, for multi-port SRS resources) cyclic shift for the Zadoff-Chu sequence that is used for SRS. The use of cyclic shifts increases the number of SRS resources that may be mapped to a comb (as SRS sequences are designed to be (almost) orthogonal under cyclic shifts), but there is a limit on how many cyclic shifts may be used (8 for comb 2 and 12 for comb 4);
The time-domain position within a given slot, configured with the RRC parameter resourceMapping, which includes:
   The time-domain start position, which is limited to be one of the last 6 symbols (in NR 3GPP Rel-15) or in any of the 14 symbols in a slot (in NR 3GPP Rel-16), configured by the RRC parameter startPosition;
   The number of symbols for the SRS resource (that may be set to 1, 2 or 4), configured by the RRC parameter nrofSymbols;
   The repetition factor (that may be set to 1, 2 or 4), configured by the RRC parameter repetitionFactor. When the repetition factor is larger than 1, the same frequency resources are used multiple times across symbols, which improves the coverage as this allows more energy to be collected by the receiver;
The sounding bandwidth, frequency-domain position and shift, and frequency-hopping pattern of an SRS resource (i.e., which part of the transmission bandwidth that is occupied by the SRS resource) is set through the RRC parameters freqDomainPosition, freqDomainShift, and the freqHopping parameters c-SRS, b-SRS, and b-hop. The smallest possible sounding bandwidth is 4 RBs;
The RRC parameter resourceType determines whether the SRS resource is transmitted as periodic, aperiodic (singe transmission triggered by DCI), or semi persistent (same as periodic except for the start and stop of the periodic transmission is controlled through MAC-CE signaling instead of RRC signaling);
The RRC parameter sequenceId specifies how the SRS sequence is initialized; and
The RRC parameter spatialRelationInfo configures the spatial relation for the SRS beam with respect to another RS (which may be another SRS, a synchronization signal block (SSB) or a channel state information reference signal (CSI-RS)). If an SRS resource has a spatial relation to another SRS resource, then this SRS resource should be transmitted with the same beam (i.e., virtualization) as the indicated SRS resource.

FIG. 1 is an illustration of an example of how an SRS resource may be allocated in time and frequency within a slot (note that semi-persistent/periodic SRS resources typically span several slots). In NR 3GPP Technical Release 16 (3GPP Rel-16), for example, the additional (and optional) RRC parameter resourceMapping-r16 was introduced. If resourceMapping-r16 is signaled, the wireless device may ignore the RRC parameter resourceMapping. The difference between resourceMapping-r16 and resourceMapping is that the SRS resource (for which the number of orthogonal frequency division multiplexed (OFDM) symbols and the repetition factor is still limited to 4) may start in any of the 14 OFDM symbols in a slot configured by the RRC parameter startPosition-r16.

In some existing systems, an SRS resource set may be configured with the following example configuration in RRC, as provided, for example, by 3GPP TS 38.331 version 16.1.0:

| | |
|---|---|
| “SRS-ResourceSet ::= | SEQUENCE { |
| srs-ResourceSetId | SRS-ResourceSetId, |
| srs-ResourceIdList | SEQUENCE (SIZE(1..maxNrofSRS- |
| ResourcesPerSet)) OF SRS-ResourceId | OPTIONAL, -- Cond Setup |
| resourceType | CHOICE { |
| aperiodic | SEQUENCE { |
| aperiodicSRS-ResourceTrigger | INTEGER (1..maxNrofSRS- |

TriggerStates−1),

| | |
|---|---|
| csi-RS | NZP-CSI-RS-ResourceId |

OPTIONAL, -- Cond NonCodebook

| | |
|---|---|
| slotOffset | INTEGER (1..32) |

```
OPTIONAL, -- Need S
        ...,
        [[
```

| | |
|---|---|
| aperiodicSRS-ResourceTriggerList | SEQUENCE |

(SIZE(1..maxNrofSRS-TriggerStates−2))

OF INTEGER (1..maxNrofSRS-

```
TriggerStates−1) OPTIONAL -- Need M
        ]]
      },
```

| | |
|---|---|
| semi-persistent | SEQUENCE { |
| associatedCSI-RS | NZP-CSI-RS-ResourceId |

```
OPTIONAL, -- Cond NonCodebook
        ...
      },
```

| | |
|---|---|
| periodic | SEQUENCE { |
| associatedCSI-RS | NZP-CSI-RS-ResourceId |

```
OPTIONAL, -- Cond NonCodebook
        ...
      }
    },
```

| | |
|---|---|
| usage | ENUMERATED {beamManagement, codebook, |

nonCodebook, antennaSwitching},

| | | |
|---|---|---|
| alpha | Alpha | OPTIONAL, -- |

Need S

| | | |
|---|---|---|
| p0 | INTEGER (−202..24) | OPTIONAL, |

-- Cond Setup

| | |
|---|---|
| pathlossReferenceRS | PathlossReferenceRS-Config |

OPTIONAL, -- Need M

| | |
|---|---|
| srs-PowerControlAdjustmentStates | ENUMERATED { sameAsFci2, |
| seperateClosedLoop} | OPTIONAL, -- Need S |

```
    ...,
    [[
```

| | |
|---|---|
| pathlossReferenceRSList-r16 | SetupRelease { PathlossReferenceRSList- |

```
r16} OPTIONAL -- Need M
    ]]
  }”
```

In some existing systems, SRS resource(s) may be transmitted as part of an SRS resource set, where all SRS resources in the same SRS resource set may share the same resource type. In some example implementations, an SRS resource set may be configurable with respect to, for example:
For aperiodic SRS, the slot offset is configured by the RRC parameter slotOffset and sets the delay from the PDCCH trigger reception to the start of the SRS transmission;
The resource usage, which is configured by the RRC parameter usage sets constraints and assumptions on the resource properties, as described, for example, in 3GPP TS 38.214. SRS resource sets may be configured with one of four different usages: ‘antennaSwitching’, ‘codebook’, ‘nonCodebook’ and ‘beamManagement’;
   An SRS resource set that is configured with usage ‘antennaSwitching’ is used for reciprocity-based DL precoding (i.e., used to sound the channel in the UL so that the network node may use reciprocity to set a suitable DL precoders). The wireless device (e.g., WD) is expected to transmit one SRS port per wireless device antenna port;
   An SRS resource set that is configured with usage ‘codebook’ is used for Codebook (CB)-based UL transmission (i.e., used to sound the different wireless device antennas and help the network node to determine/signal a suitable UL precoder, transmission rank, and Modulation Coding Scheme (MCS) for PUSCH transmission). There are up to two SRS resources in an SRS resource set with usage ‘codebook’. How SRS ports are mapped to wireless device antenna ports is, however, up to the wireless device implementation and not known to the network node;
   An SRS resource set that is configured with usage ‘nonCodebook’ is used for nonCodebook (NCB)-based UL transmission. Specifically, the wireless device may transmit one SRS resource per candidate beam (suitable candidate beams are determined by the wireless device based on CSI-RS measurements in the DL and, hence, reciprocity needs to hold). The network node may then, by indicating a subset of these SRS resources, determine which UL beam(s) the wireless device should apply for PUSCH transmission. One UL layer will be transmitted per indicated SRS resource. Note that how the wireless device maps SRS ports to antenna ports is up to wireless device implementation and not known to the network node;
An SRS resource set that is configured with usage ‘beamManagement’ is used (mainly for frequency bands above 6 GHz (i.e., for FR2)) to evaluate different WD beams for analog beamforming arrays. The wireless device transmits one SRS resource per analog beam, and the network node will perform a Reference Signal Received Power (RSRP) measurement per transmitted SRS resource and, in this way, determine a suitable wireless device beam that is reported to the wireless device;
The associated CSI-RS (this configuration is only applicable for NCB-based UL transmission) for each of the possible resource types;
   For an aperiodic SRS, the associated CSI-RS resource is set by the RRC parameter csi-RS;
   For semi-persistent/periodic SRS, the associated CSI-RS resource is set by the RRC parameter associated CSI-RS; and
The Power Control (PC) parameters, e.g., alpha and p0, are used for setting the SRS transmission power. SRS has its own UL PC scheme in NR (e.g., as described in 3GPP TS 38.213), which specifies how the wireless device should split the available output power between two or more SRS ports during one SRS transmit occasion (an SRS transmit occasion is a time window within a slot where SRS transmission is performed).

To summarize, the SRS resource-set configuration determines, e.g., usage, power control, and slot offset for aperiodic SRS. The SRS resource configuration determines the time-and-frequency allocation, the periodicity and offset, the sequence, and the spatial-relation information.

### SRS Antenna Switching

It may be desirable for the network node to sound all wireless device antennas (where sounding an antenna means transmitting an SRS from that antenna, which, in turn, enables the network node to estimate the channel between said wireless device antenna and the antennas at the network node), but it may also be costly to equip the wireless device with many transmit ports. SRS antenna switching was introduced in NR 3GPP Rel-15, for several different wireless device architectures for which the number of receive chains is larger than the number of transmit chains. If a wireless device supports antenna switching, it will report so by means of WD-capability signaling.

The left column of Table 1 below (which is from 3GPP TS 38.306) lists SRS antenna-switching capabilities that may be reported from a wireless device in NR 3GPP Rel-15. For example, if a wireless device reports t1r2 in the WD-capability signaling, it means that it has two receive antennas (i.e., two receive chains) but only has the possibility of transmitting from one of those antennas at a time (i.e., one transmission chain) with support for antenna switching. In this case, two single-port SRS resources may be configured to the wireless device such that it may sound both receive ports using a single transmit port with an antenna switch in between.

TABLE 1
SRS Antenna-Switching Capability
Reporting from 3GPP TS 38.306

| supportedSRS-TxPortSwitch | supportedSRS-TxPortSwitch-v1610 |
|---|---|
| t1r2 | t1r1-t1r2 |
| t1r4 | t1r1-t1r2-t1r4 |
| t2r4 | t1r1-t1r2-t2r2-t2r4 |
| t2r2 | t1r1-t2r2 |
| t4r4 | t1r1-t2r2-t4r4 |
| t1r4-t2r4 | t1r1-t1r2-t2r2-t1r4-t2r4 |

Additional wireless device capabilities were further introduced in NR 3GPP Rel-16, as shown in the right-hand column of Table 1, which indicates support for the wireless device to be configured with SRS resource set(s) with usage ‘antennaSwitching’ but where only a subset of all wireless device antennas is sounded. For example, the WD capability t1r1-t1r2 means that the network node may configure one single-port SRS resource (i.e., the same as no antenna-switching capability) or two single-port SRS resources (i.e., the same as for the capability “t1r2” described above) with usage ‘antennaSwitching’ per SRS resource set. In this case, if the wireless device is configured with a single SRS resource (no antenna switching) it will sound only one of its two antennas, which will conserve wireless device power at the cost of reduced channel knowledge at the network node (since the network node may only estimate the channel between itself and the wireless device based on one of the two wireless device antennas).

For SRS resources with usage ‘antennaSwitching’ for a wireless device with a fewer number of transmission (TX) chains than number of reception (RX) chains, a guard period has to be configured between SRS resources to account for TX switching transient time. For subcarrier spacing below 120 kHz the guard period is 1 OFDM symbol, while for sub-carrier spacing of 120 kHz it is 2 OFDM symbols. This means that a wireless device is expected to be able to switch antenna within one or two OFDM symbols, depending on sub-carrier spacing.

### Multi-Beam Operation

### Beam Management Procedure

In some existing systems, for example, in high frequency range (FR2) configurations, multiple RF beams may be used to transmit and receive signals at a network node and a WD. For each DL beam from a network node, there is typically an associated best WD Rx beam for receiving signals from the DL beam. The DL beam and the associated WD Rx beam form a beam pair. The beam pair may be identified through a beam management process in NR.

A DL beam is (typically) identified by an associated DL reference signal (RS) transmitted in the beam, either periodically, semi-persistently, or aperiodically. The DL RS for the purpose may be a Synchronization Signal (SS) and Physical Broadcast Channel (PBCH) block (SSB) or a Channel State Information RS (CSI-RS). By measuring all the DL RSs, the WD may determine and report to the network node the best DL beam to use for DL transmissions. The network node may then transmit a burst of DL-RS in the reported best DL beam to let the WD evaluate candidate WD RX beams.

Although not explicitly stated in the NR specification, beam management has been divided into three procedures, schematically illustrated in FIG. 2, which is an illustration of an example beam management procedure. The procedures may include, for example:
P-1: A purpose of the P-1 procedure is to find a coarse direction for the WD using wide network node TX beam covering the whole angular sector;
P-2: A purpose of the P-2 procedure is to refine the network node TX beam by doing a new beam search around the coarse direction found in P1; and
P-3: A purpose of the P-3 procedure is to be used for a WD that has analog beamforming to enable it to find a suitable WD RX beam.

P-1 may utilize beams with rather large beamwidths and where the beam reference signals are transmitted periodically and are shared between all WDs of the cell. Typically reference signal to use for P-1 are periodic CSI-RS or SSB. The WD then reports the N best beams to the network node and their corresponding RSRP values.

P-2 may use aperiodic/or semi-persistent CSI-RS transmitted in narrow beams around the coarse direction found in P-1.

P-3 may use aperiodic or semi-persistent CSI-RSs repeatedly transmitted in one narrow network node beam. One alternative technique is to configure the WD to determine a suitable WD RX beam based on the periodic SSB transmission. Since each SSB consists of four OFDM symbols, a maximum number of four WD RX beams may be evaluated during each SSB burst transmission. One benefit of using SSB instead of CSI-RS is that no extra overhead of CSI-RS transmission is needed.

### Beam Indication

In some existing NR systems, several signals may be transmitted from different antenna ports of the same base station. These signals may have the same large-scale properties such as Doppler shift/spread, average delay spread, and/or average delay. Such antenna ports may be considered quasi co-located (QCL).

If the WD knows that two antenna ports are QCL with respect to a certain parameter (e.g., Doppler spread), the WD may estimate that parameter based on one of the antenna ports and apply that estimate for receiving a signal on the other antenna port.

For example, there may be a QCL relation between a CSI-RS for tracking RS (TRS) and the PDSCH Demodulation Reference Signal (DMRS). When WD receives the PDSCH DMRS, it may use the measurements already made on the TRS to assist the DMRS reception.

Information about what assumptions may be made regarding QCL may be signaled to the WD from the network, e.g., from a network node. In NR, for example, four types of QCL relations between a transmitted source RS and a transmitted target RS have been defined:
Type A: {Doppler shift, Doppler spread, average delay, delay spread};
Type B: {Doppler shift, Doppler spread};
Type C: {average delay, Doppler shift}; and
Type D: {Spatial Rx parameter}.

QCL type D was introduced in NR to facilitate beam management with analog beamforming and is also known as spatial QCL. There is currently no strict definition of spatial QCL, but the understanding is that if two transmitted antenna ports are spatially QCL, the WD may use the same Rx beam to receive them. This may be beneficial for a WD that uses analog beamforming to receive signals, since the WD needs to adjust its RX beam in some direction prior to receiving a certain signal. If the WD knows that the signal is spatially QCL with some other signals it has received earlier, then it may safely use the same RX beam to receive this signal as well.

In NR, the spatial QCL relation for a DL or UL signal/channel may be indicated to the WD by using a “beam indication”. The “beam indication” may be used to assist the WD in finding a suitable RX beam for DL reception, and/or a suitable TX beam for UL transmission. In NR, the “beam indication” for DL may be conveyed to the WD by indicating a transmission configuration indicator (TCI) state to the WD, while in UL the “beam indication” may be conveyed by indicating a DL-RS or UL-RS as spatial relation (in NR 3GPP Rel-15/16) or a TCI state (in NR 3GPP Rel-17).

### UL Beam Management

In some existing systems, some WDs may have analog beamformers without beam correspondence or with poor beam correspondence, which implies that DL/UL reciprocity cannot be used to determine the beams for these beamformers. For such WDs, the WD beam used for UL cannot be derived from beam management procedures based on DL reference signals as described above. To handle such WDs, UL beam management has been included in the NR standard specification since 3GPP Rel-15. One difference between normal beam management and UL beam management is that UL beam management utilizes uplink reference signals instead of DL references signals. UL reference signals, for example, sounding reference signals (SRS), may be used for UL beam management. Two UL beam management procedures are supported in NR: U2 and U3, which are schematically illustrated in FIG. 3, which is an illustration of an example uplink beam management procedure.

For example, in some existing systems, the U2 procedure is performed by the WD transmitting a burst of SRS resources using one WD TX beam per SRS and the network node (e.g., TRP) is configured to evaluate the reception at different network beams (TRP RX) beams. This gives an understanding of the difference in quality of the different beam pair links associated to the WD TX beam the WD uses. For example, for a given WD Tx beam (e.g., SRS X being transmitted by the WD), the network node receives the SRS X in gNB Rx beam 1, gNB Rx beam 2, . . . , gNB Rx beam K so the network node determines the quality of the beam link pairs (WD TX beam, gNB Rx beam 1); (WD TX beam, gNB Rx beam 2); . . . ; (WD TX beam, gNB Rx beam K).

The U3 procedure lets the WD evaluate a suitable WD TX beam by transmitting different SRS resources in different WD TX beams (e.g., SRS 1, 2, . . . , K being transmitted by the WD). This gives an understanding of the difference in quality of the different beam pair links associated to the gNB RX beam X so that the network node determines the quality of the beam link pairs (WD TX beam 1, gNB Rx beam X); (WD TX beam 2, gNB Rx beam X); . . . ; (WD TX beam K, gNB Rx beam X).

For WDs, the signals may arrive and emanate from all different directions. Hence, it is beneficial to have an antenna implementation at the WD which has the possibility to generate omni-directional-like coverage in addition to the high gain narrow beams. For example, one way to increase the omni-directional coverage at a WD is to install multiple panels, and point the panels in different directions, which may typically be the case for commercial WDs. However, in order to reduce the cost and energy consumption, these WDs may only transmit from one WD panel at each time instance.

FIG. 4 illustrates one example of a realistic WD with two baseband chains (e.g., one per polarization) which may be used to switch between three different dual-polarized panels. In the example of FIG. 4, the two panels point in opposite directions, which may improve coverage. The WD in the example of FIG. 4 has one baseband chain that may be connected to one of the two panels, which may depend on a switch setting.

FIG. 5 illustrates a WD panel of a commercial WD that may be configured to generate beams of different beam widths. Typically, commercial WDs may generate the wider beams by turning off one or multiple power amplifiers (PAs) of the panel, which may have a negative impact on the available output power. However, it may be possible to mitigate the power loss when generating wide beams by applying dual-polarized beamforming (e.g., using array size invariant (ASI) beamforming). It may be useful for the network node to generate a wide beam of a panel during beam sweep procedures to first find a coarse direction to a serving network node (e.g., AP/TRP/etc.). This would enable the WD to select and activate a suitable WD panel. In this example, the WD may generate one wide beam, 5 half-wide beams, or 9 narrow beams for each panel.

### Beam Prediction

One example Artificial Intelligence (AI)/Machine Learning (ML) (AI/ML) model currently discussed in the AI for air-interface 3GPP Rel-18 includes predicting the channel with respect to a beam for a certain time-frequency resource. The expected performance of such predictor depends on several different aspects, for example, time/frequency variation of channel due to WD mobility or changes in the environment. Due to the inherit correlation in time, frequency and the spatial domain of the channel, an ML-model may be trained to exploit such correlations. The spatial domain may include one or more different beams, where the correlation properties may partly depend on how the network node antennas form the different beams, and how the WD forms the receiver beams.

The device may use such prediction AI/ML model to reduce its measurement related to beamforming. In NR, one may request a device to measure on a set of SSB beams or/and CSI-RS beams. A stationary device typically experiences less variations in beam quality in comparison to a moving device. The stationary device may be able to save battery and reduce the number of beam measurements by instead using an AI/ML model to predict the beam quality, e.g., without an explicit measurement. It may do this, for example, by measuring a subset of the beams and predicting the rest of the beams.

A WD may predict future beam values based, e.g., on historical values. Based on received device data from measurement reports, the network node may be able to learn, for example, which sequences of signal quality measurements (e.g., RSRP measurements) lead to large signal quality drop events (e.g., turning around the corners, as depicted in the example scenario illustrated in FIG. 6). This learning procedure may be enabled, for example, by dividing periodically reported RSRP data into a training and prediction window of an AI/ML model.

In the example of FIG. 6, two devices move along similar paths, and turn around the same corner. Device 120b, marked by dashed line, is the first to turn around the corner and experience a large signal quality drop. An AI/ML model may be able to mitigate the drop of a second device (120a) by using learning from the first device's (Device 120b) experiences.

The AI/ML model learning may be performed by feeding RSRP at times t₁, . . . , tₙ into an AI/ML model (e.g., a neural network), and then learning the RSRP in times tₙ₋₁, tₙ₊₂. After the model is trained, the network node may then predict future signal quality values, where the signal quality prediction may be used to avoid radio-link failure, beam failure, etc., by, for example:
Initiating inter-frequency handover;
Setting handover/reselection parameters;
Pre-emptively performing candidate beam selection to avoid beam failure; and/or
Changing device scheduler priority, for example schedule device when the expected signal quality is good.

AI/ML-based beam management procedures for DL spatial and temporal beam prediction may be applied, for example, in use cases for determining a preferred network node Tx beam, for example, by the network node being deployed with an AI/ML model which is able to predict the best DL beam in a future time occasion (time-domain prediction) and/or predicting a Tx beam based on reference signals transmitted in another Tx beam (spatial-domain prediction). A problem which may arise in such a configuration, however, is that it usually takes very long time for the WD to determine a suitable WD beam for a given network node beam. In some configurations, for example, it may take up to 1 sec for a WD to find a suitable WD beam. In case a WD is moving/rotating, the delay of one second to find a suitable WD beam, will significantly reduce the performance.

Another issue with AI/ML-based network-sided beam prediction is that the network has no knowledge about what WD panel and/or WD beam the WD is using. Since the WD might use different WD panels/WD beams during the model training phase than what the WD uses during the inference phase, the prediction of the network node TX beam at the network side becomes difficult.

To solve the above problems, network-sided beam pair prediction (i.e., predicting a preferred pair of a network node TX beam and a WD RX beam for a DL transmission or predicting a preferred pair of a WD TX beam and a network node RX beam for an UL transmission) may be provided.

For example, one solution includes configuring the network to have the information about all candidate beam-pair links to train/retrain its AI/ML model for beam pair prediction. In NR, there is no mechanism to support the network to collect such information. Hence, a solution is needed to support the network node to use SRS transmissions to collect the raw data (e.g., channel measurements and identifiers of different beam-pair links and the associated assistance information) for training its beam pair prediction AI/ML model.

After the AI/ML model has been trained and deployed at the network node, the network node may use the AI/ML model to perform beam pair prediction (i.e., the model inference phase) using the beam measurements collected from UL-RS transmissions.

One problem, however, with the inference of the UL-RS based network-sided spatial beam pair link prediction, is that the AI/ML model at the network node side needs to have channel measurements of a subset of beam pairs as input for model inference. This requires the network node to be able to configure a WD to perform the UL-RS transmission in a selected subset of WD beams.

Another problem is, after model inference, how to enable the network node to indicate/instruct the WD to use the WD beam that is associated to the predict beam pair for transmitting/receiving data/signals.

Thus, existing systems may lack adequate procedures for configuring and signalling UL-RS based network-sided spatial beam pair link prediction.

### SUMMARY

Some embodiments advantageously provide methods, systems, and apparatuses for network-sided inference of beam pair prediction using UL-RS.

In some embodiments of the present disclosure, for example, a method is provided at a WD for assisting the network node to perform inference of an AI/ML based network-sided beam pair link prediction based on UL reference signals. The method includes receiving a message containing UL reference signal configuration. The method may include receiving an indication of a mapping between at least a WD beam and an UL reference signal (e.g., WD beam 1 and UL RS A). The method may include transmitting the UL reference signals according to the UL reference signal configuration and the mapping between the UL reference signal and the WD beam. Optionally, the method may include providing the network node with WD assistance information. The method may include receiving a beam indication message containing an indication of the selected UL-RS (e.g., UL-RS ID), and updating the WD beam (spatial filter) based on the indication of the selected UL-RS, where the selection of UL-RS may consider the previously attained mapping between a WD beam and an UL reference signal. The method may include using the updated WD beam (e.g., spatial filter) for transmitting and/or receiving control and data payloads.

Some embodiments of the present disclosure may enable the inference of AI/ML-based network-sided beam pair link prediction for 5G advance and/or 6G, where a beam pair link to be used is determined based on the measurements on a subset of all beam pair inks. By only measuring a subset of all beam pair links, the overhead, the uplink interference, and latency during beam management procedures for mmWave and sub-terra HZ communication will be reduced compared to measuring on all beam pair links (measuring all beam pair links might not be reasonable with regard to overhead and latency, due to the significant amount of beam pair links that might exist between a network node and a WD). Another benefit, e.g., for the WD, is that the WD may transmit fewer UL RSs as the network node would be able to predict some of the beam pairs for which the WD is not transmitting an UL RS, thanks to the AI/ML model at the network side.

Another benefit with determining a beam pair link to be used instead of, for example, determining only a network node beam, is that it usually takes a very long time for the WD to determine a suitable WD beam for a given network node beam. Commercial mmWave measurement tests have shown that it may take up to 1 sec for a WD to find a suitable WD beam. In case a WD is moving/rotating, the delay of one second to find a suitable WD beam, will significantly reduce the performance. By directly determining a beam pair link, i.e., a network node beam and a WD beam, the latency of beam finding procedure may be significantly reduced compared to existing systems, and the performance for moving/rotating WD may be significantly increased.

According to one aspect, a method in a wireless device, WD, configured to communicate with a network node is provided. The method includes determining a mapping between M beams corresponding to M spatial filters of the WD and M beam identifications, IDs, M being an integer greater than zero. The method includes receiving a configuration of uplink reference signals. The method includes transmitting N uplink reference signals of the received configuration in N beams of the M beams, N being an integer not greater than M.

According to this aspect, in some embodiments, the N beams used to transmit the N uplink reference signals are indicated to the WD by indicating N of M beam IDs. In some embodiments, a beam ID of the M beam IDs is an uplink reference signal ID. In some embodiments, the method includes receiving a selected beam ID indicating a beam of the WD selected by the network node from the M beams. In some embodiments, the selected beam ID is based at least in part on measurements on the N uplink reference signals. In some embodiments, the selected beam ID is determined by an artificial intelligence, AI, model. In some embodiments, the method includes at least one of transmitting and receiving control and data payloads on a beam to which the selected beam ID is mapped. In some embodiments, the determined mapping is obtained from the network node. In some embodiments, the method includes storing an uplink reference signal ID for each of the N uplink reference signals. In some embodiments, transmitting the N uplink reference signals is in response to a trigger received from the network node. In some embodiments, the method includes transmitting an antenna configuration ID and a mapping between the antenna configuration ID and a beam ID. In some embodiments, the method includes transmitting an indication of at least one of a number of antenna ports per beam and a number of antenna ports per antenna panel. In some embodiments, the method includes transmitting a mapping of beams to antenna panels of the WD. In some embodiments, the method includes transmitting an indication of beams that may be transmitted simultaneously by the WD. In some embodiments, the method includes associating uplink reference signal resources to different antenna panels of the WD. In some embodiments, the method includes transmitting assistance information associated with transmission of the N beams, the assistance information including at least one of an antenna orientation, a WD position, velocity and direction, and non-line-of-sight information.

According to another aspect, a wireless device, WD, configured to communicate with a network node is provided. The WD includes processing circuitry configured to determine a mapping between M beams corresponding to M spatial filters of the WD and M beam identifications, IDs, M being an integer greater than zero. The WD includes a radio interface in communication with the processing circuitry and configured to: receive a configuration of uplink reference signals; and transmit N uplink reference signals of the received configuration in N beams, N being an integer not greater than M.

According to this aspect, in some embodiments, the N beams used to transmit the N uplink reference signals are indicated to the WD by indicating N of M beam IDs. In some embodiments, a beam ID of the M beam IDs is an uplink reference signal ID. In some embodiments, the radio interface is configured to receive a selected beam ID indicating a beam of the WD selected by the network node from the M beams. In some embodiments, the selected beam ID is based at least in part on measurements on the N uplink reference signals. In some embodiments, the radio interface is configured to the selected beam ID is determined by an artificial intelligence, AI, model. In some embodiments, the radio interface is configured to the radio interface is configured to at least one of transmit and receive control and data payloads on a beam to which the selected beam ID is mapped. In some embodiments, the determined mapping is obtained from the network node. In some embodiments, the processing circuitry is further configured to store an uplink reference signal ID for each of the N uplink reference signals. In some embodiments, transmitting the N uplink reference signals is in response to a trigger received from the network node. In some embodiments, the radio interface is configured to transmit an antenna configuration ID and a mapping between the antenna configuration ID and a beam ID. In some embodiments, the radio interface is further configured to transmit an indication of at least one of a number of antenna ports per beam and a number of antenna ports per antenna panel. In some embodiments, the radio interface is further configured to transmit a mapping of beams to antenna panels of the WD. In some embodiments, the radio interface is configured to transmit an indication of beams that may be transmitted simultaneously by the WD. In some embodiments, the processing circuitry is further configured to associate uplink reference signal resources to different antenna panels of the WD. In some embodiments, the radio interface is further configured to transmit assistance information associated with transmission of the N beams, the assistance information including at least one of an antenna orientation, a WD position, velocity and direction, and non-line-of-sight information.

According to yet another aspect, a method in a network node configured to communicate with a wireless device, WD, is provided. The method includes receiving M uplink reference signals transmitted by the WD in M respective beams, M being a integer greater than zero. The method also includes performing a measurement on each of the received M uplink reference signals. The method further includes selecting an uplink reference signal out of the M uplink reference signals based at least in part on an artificial intelligence, AI, model receiving the measurements as inputs.

According to this aspect, in some embodiments, the method includes sending an uplink reference signal identification, ID, to the WD, the uplink reference signal ID indicating the selected uplink reference signal. In some embodiments, the method includes configuring the WD with a mapping between N beams and N beam identifications, IDs. In some embodiments, the method includes transmitting a triggering signal to trigger the WD to transmit the M uplink reference signals. In some embodiments, the method includes receiving from the WD an antenna configuration ID and a mapping between the antenna configuration ID and a beam ID. In some embodiments, the method includes receiving from the WD an indication of at least one of a number of antenna ports per beam and a number antenna ports per antenna panel. In some embodiments, the method includes receiving from the WD a mapping of beams to antenna panels of the WD. In some embodiments, the method includes receiving an indication of beams that may be transmitted simultaneously by the WD. In some embodiments, the method includes receiving from the WD assistance information associated with transmission of the M beams, the assistance information including at least one of an antenna orientation, a WD position, velocity and direction, and non-line-of-sight information.

According to another aspect, a network node configured to communicate with a wireless device, WD, is provided. The network node includes a radio interface configured to receive M uplink reference signals transmitted by the WD in M respective beams, M being a integer greater than zero. The network node also includes processing circuitry in communication with the radio interface and configured to: perform a measurement on each of the received M uplink reference signals; and select an uplink reference signal out of the M uplink reference signals based at least in part on an artificial intelligence, AI, model receiving the measurements as inputs.

According to this aspect, in some embodiments, the radio interface is further configured to send an uplink reference signal identification, ID, to the WD, the uplink reference signal ID indicating the selected uplink reference signal. In some embodiments, the processing circuitry is further configured to configure the WD with a mapping between the N beams and N beam identifications, IDs. In some embodiments, the radio interface is further configured to transmit a triggering signal to trigger the WD to transmit the M uplink reference signals. In some embodiments, the radio interface is further configured to receive from the WD an antenna configuration ID and a mapping between the antenna configuration ID and a beam ID. In some embodiments, the radio interface is configured to receive from the WD an indication of at least one of a number of antenna ports per beam and a number antenna ports per antenna panel. In some embodiments, the radio interface is further configured to receive from the WD a mapping of beams to antenna panels of the WD. In some embodiments, the radio interface is further configured to receive an indication of beams that may be transmitted simultaneously by the WD. In some embodiments, the radio interface is further configured to receive from the WD assistance information associated with transmission of the M beams, the assistance information including at least one of an antenna orientation, a WD position, velocity and direction, and non-line-of-sight information.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic description of an example SRS resource allocation configuration in time and frequency within a slot;

FIG. 2 is an illustration of an example beam management procedure;

FIG. 3 is an illustration of another example beam management procedure;

FIG. 4 is an illustration of an example WD configured with two panels pointing in opposite directions;

FIG. 5 is an illustration of an example configuration of WD beams of different beam widths;

FIG. 6 is an illustration of an example scenario of two devices moving on similar paths;

FIG. 7 is a schematic diagram of an example network architecture illustrating a communication system connected via an intermediate network to a host computer according to the principles in the present disclosure;

FIG. 8 is a block diagram of a host computer communicating via a network node with a WD over an at least partially wireless connection according to some embodiments of the present disclosure;

FIG. 9 is a flowchart illustrating example methods implemented in a communication system including a host computer, a network node and a WD for executing a client application at a WD according to some embodiments of the present disclosure;

FIG. 10 is a flowchart illustrating example methods implemented in a communication system including a host computer, a network node and a WD for receiving user data at a WD according to some embodiments of the present disclosure;

FIG. 11 is a flowchart illustrating example methods implemented in a communication system including a host computer, a network node and a WD for receiving user data from the WD at a host computer according to some embodiments of the present disclosure;

FIG. 12 is a flowchart illustrating example methods implemented in a communication system including a host computer, a network node and a WD for receiving user data at a host computer according to some embodiments of the present disclosure;

FIG. 13 is a flowchart of an example process in a network node for network-sided inference of beam pair prediction using UL-RS according to some embodiments of the present disclosure;

FIG. 14 is a flowchart of an example process in a WD for network-sided inference of beam pair prediction using UL-RS according to some embodiments of the present disclosure;

FIG. 15 is a flowchart of another example process a network node for network-sided inference of beam pair prediction using UL-RS according to some embodiments of the present disclosure;

FIG. 16 is a flowchart of another example process in a WD for network-sided inference of beam pair prediction using UL-RS according to some embodiments of the present disclosure;

FIG. 17 is a flowchart of another example process a network node for network-sided inference of beam pair prediction using UL-RS according to some embodiments of the present disclosure;

FIG. 18 is a flowchart of another example process in a WD for network-sided inference of beam pair prediction using UL-RS according to some embodiments of the present disclosure;

FIG. 19 is schematic illustrating an example configuration of beam pair links between a WD and a network node;

FIG. 20 is a schematic and timing diagram illustrating an example method for inference of a beam pair link prediction according to some embodiments of the present disclosure;

FIG. 21 is another schematic and timing diagram illustrating an example method for inference of a beam pair link prediction according to some embodiments of the present disclosure;

FIG. 22 is a flowchart of an example process of exchange of communications between a network node and a WD for inference of a beam pair link prediction according to some embodiments of the present disclosure;

FIG. 23 is a flowchart of another example process of exchange of communications between a network node and a WD for inference of a beam pair link prediction according to some embodiments of the present disclosure;

FIG. 24 is an example of mapping between uplink reference signal resources and WD beams according to principles disclosed herein; and

FIG. 25 is another example of mapping between uplink reference signal resources and WD beams according to principles disclosed herein.

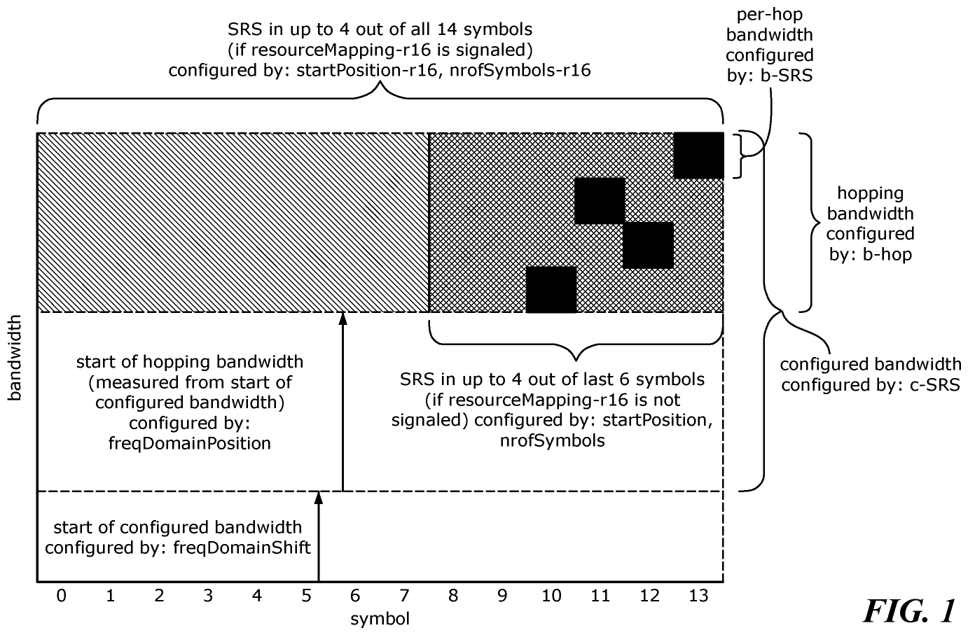

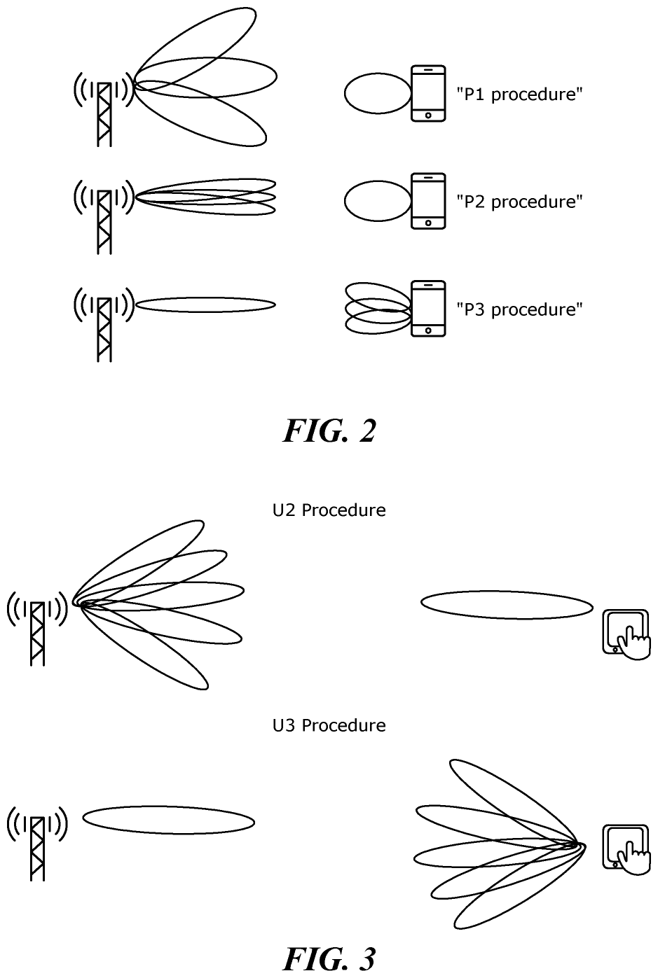

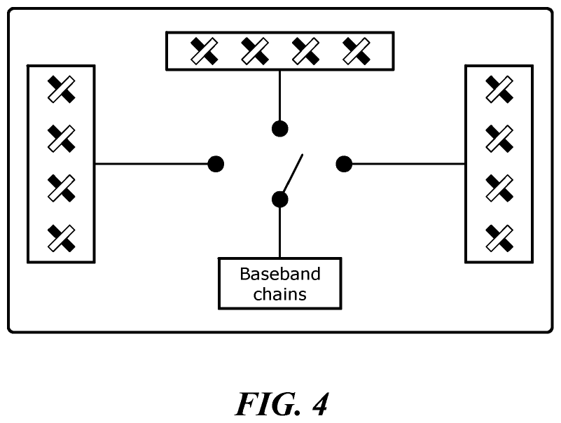

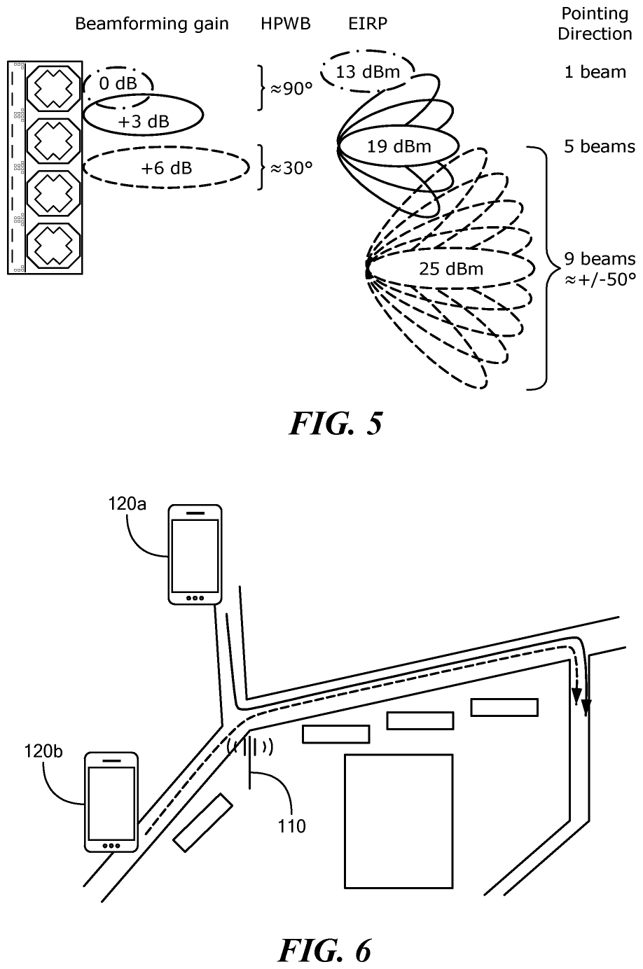

### DETAILED DESCRIPTION

Before describing in detail example embodiments, it is noted that the embodiments reside primarily in combinations of apparatus components and processing steps related to network-sided inference of beam pair prediction using UL-RS. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Note further that the terms “beam”, “spatial directions” and “spatial filter” may be used interchangeably in describing one or more embodiments of the present disclosure.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide methods, apparatuses, and systems for network-sided inference of beam pair prediction using UL-RS.

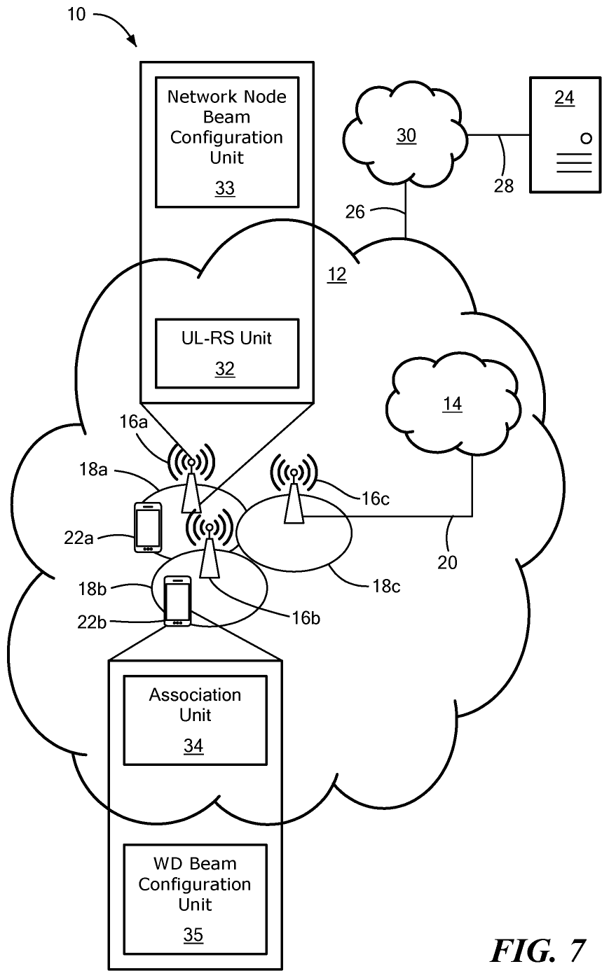

Referring again to the drawing figures, in which like elements are referred to by like reference numerals, there is shown in FIG. 7 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 7 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 may be configured to include a UL-RS unit 32 which may be configured to configure an uplink, UL, reference signal (RS) configuration of at least one UL reference signal resource. A wireless device 22 may be configured to include an association unit 34 which may be configured to determine an association between UL-RS resources and beams of the WD 22. The network node 16 is configured to include a Network Node Beam Configuration Unit 33 which is configured for network-sided inference of beam pair prediction using UL-RS. The wireless device 22 is configured to include a Wireless Device Beam Configuration Unit 35 which is configured for network-sided inference of beam pair prediction using UL-RS.

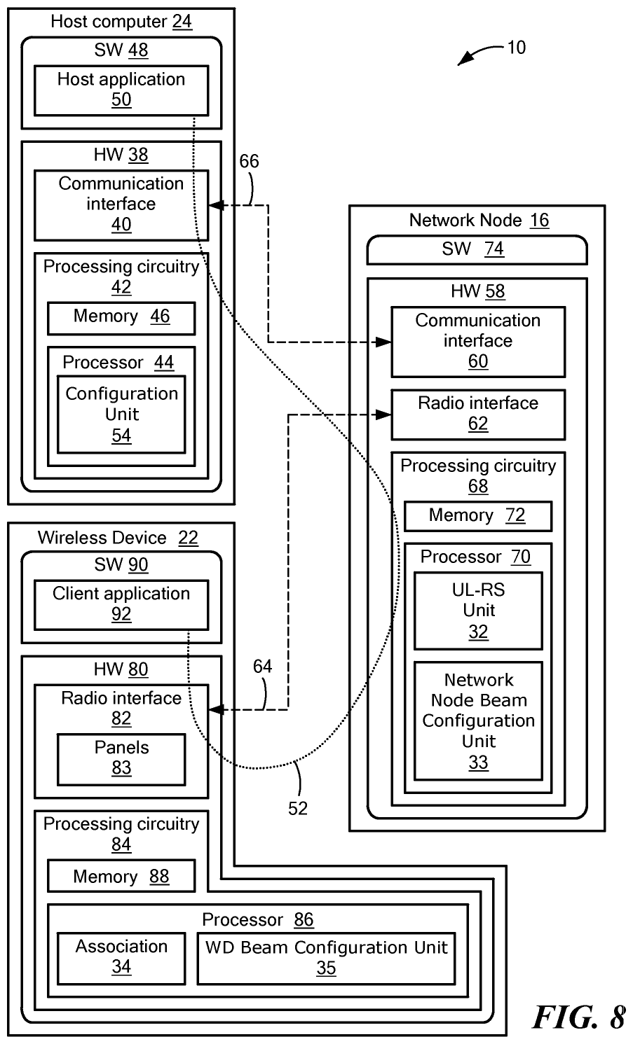

Example implementations, in accordance with an embodiment, of the WD 22, network node 16 and host computer 24 discussed in the preceding paragraphs will now be described with reference to FIG. 8. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a Configuration Unit 54 configured to enable the service provider to observe/monitor/control/transmit to/receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a UL-RS unit 32 which is configured to configure an uplink, UL, reference signal (RS) configuration of at least one UL reference signal resource. For example, processing circuitry 68 of the network node 16 may include Network Node Beam Configuration Unit 33 configured for network-sided inference of beam pair prediction using UL-RS.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers, and may include and/or may be arranged as one or more panels 83, each of which may be associated with one or more panel 83 directions/orientations/configurations.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an association unit 34 which is configured to determine an association between UL-RS resources and beams of the WD 22. For example, the processing circuitry 84 of the wireless device 22 may include a Wireless Device Beam Configuration Unit 35 configured network-sided inference of beam pair prediction using UL-RS.

In some embodiments, the inner workings of the network node 16, WD 22, and host computer 24 may be as shown in FIG. 8 and independently, the surrounding network topology may be that of FIG. 7.

In FIG. 8, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 7 and 8 show various “units” such as UL-RS unit 32, Network Node Beam Configuration Unit 33, association unit 34, and Wireless Device Beam Configuration Unit 35 as being within a respective processor, it is contemplated that these units may be implemented such that a portion of the unit is stored in a corresponding memory within the processing circuitry. In other words, the units may be implemented in hardware or in a combination of hardware and software within the processing circuitry.

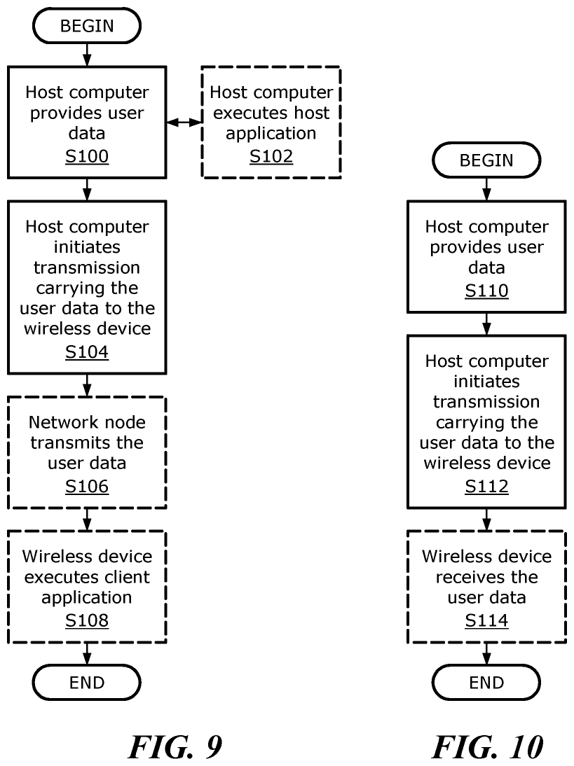

FIG. 9 is a flowchart illustrating an example method implemented in a communication system, such as, for example, the communication system of FIGS. 7 and 8, in accordance with one embodiment. The communication system may include a host computer 24, a network node 16 and a WD 22, which may be those described with reference to FIG. 8. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 10 is a flowchart illustrating an example method implemented in a communication system, such as, for example, the communication system of FIG. 7, in accordance with one embodiment. The communication system may include a host computer 24, a network node 16 and a WD 22, which may be those described with reference to FIGS. 7 and 8. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

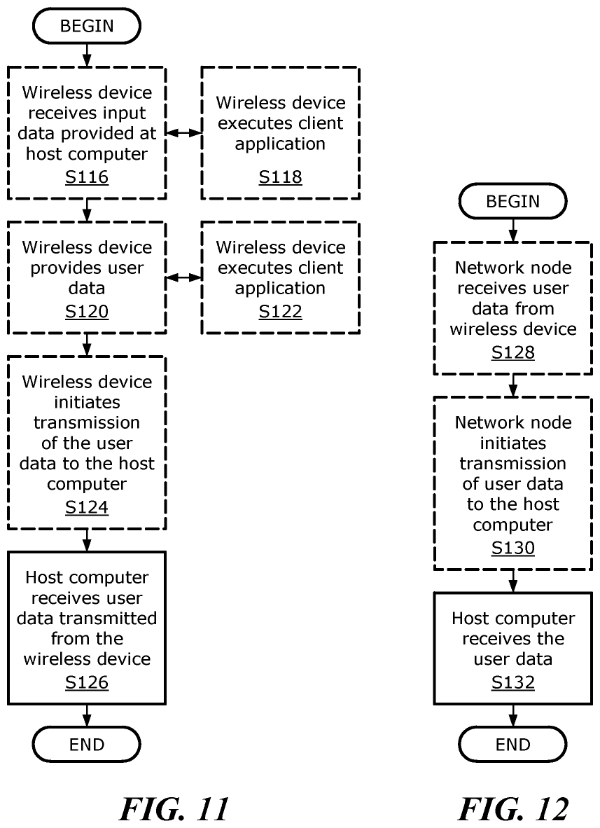

FIG. 11 is a flowchart illustrating an example method implemented in a communication system, such as, for example, the communication system of FIG. 7, in accordance with one embodiment. The communication system may include a host computer 24, a network node 16 and a WD 22, which may be those described with reference to FIGS. 7 and 8. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 12 is a flowchart illustrating an example method implemented in a communication system, such as, for example, the communication system of FIG. 7, in accordance with one embodiment. The communication system may include a host computer 24, a network node 16 and a WD 22, which may be those described with reference to FIGS. 7 and 8. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

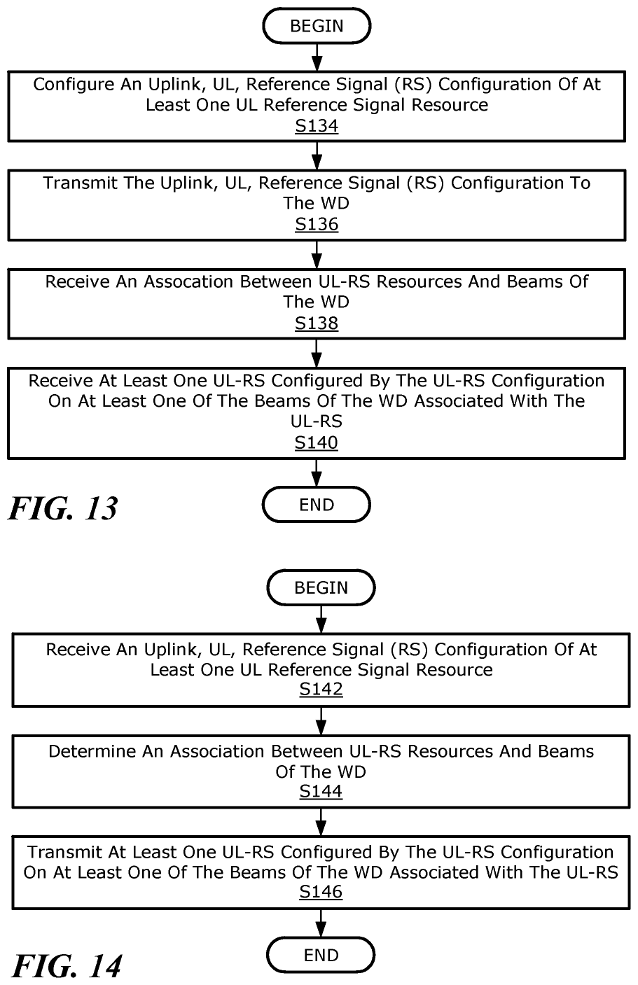

FIG. 13 is a flowchart of an example process in a network node 16 for sounding reference signal (SRS)-based collection to support beam pair prediction model training. One or more blocks described herein may be performed by one or more elements of network node 16 such as by one or more of processing circuitry 68 (including the UL-RS unit 32), processor 70, radio interface 62 and/or communication interface 60. Network node 16 such as via processing circuitry 68 and/or processor 70 and/or radio interface 62 and/or communication interface 60 is configured to configure an uplink, UL, reference signal (RS) configuration of at least one UL reference signal resource (Block S134). The process includes transmitting an uplink, UL, reference signal (RS) configuration to the WD (Block S136). The process includes receiving an association between UL-RS resources and beams of the WD 22 (Block S138). The process further includes receiving at least one UL-RS configured by the UL-RS configuration on at least one of the beams of the WD 22 associated with the UL-RS (Block S140).

In some embodiments, the method also includes receiving a capability of the WD 22 to support UL-RS data collection for beam pair link prediction by the network node 16. In some embodiments, the capability includes at least one of a total number of beams per antenna panel of the WD 22 to be used for beam pair link data collection, and a total number of beams per antenna panel of the WD 22 to be used for beam pair link data collection. In some embodiments, the method also includes transmitting an indication of a mapping between beams of the WD 22 and UL-RS resources. In some embodiments, the method also includes receiving an indication from the WD 22 of a set of UL-RS resources used by the WD 22 for data collection.

FIG. 14 is a flowchart of an example process in a WD 22 according to some embodiments of the present disclosure for network-sided inference of beam pair prediction using UL-RS. One or more blocks described herein may be performed by one or more elements of wireless device 22 such as by one or more of processing circuitry 84 (including the Wireless Device Beam Configuration Unit 35), processor 86, radio interface 82 and/or communication interface 60. Wireless device 22 such as via processing circuitry 84 and/or processor 86 and/or radio interface 82 is configured to receive an uplink, UL, reference signal (RS) configuration of at least one UL reference signal resource (Block S142). The process also includes determining an association between UL-RS resources and beams of the WD 22 (Block S144). The process also includes transmitting at least one UL-RS configured by the UL-RS configuration on at least one of the beams of the WD 22 associated with the UL-RS (Block S146).

In some embodiments, the method also includes transmitting a capability of the WD 22 to support UL-RS data collection for beam pair link prediction by the network node 16. In some embodiments, the capability includes at least one of a total number of beams per antenna panel of the WD 22 to be used for beam pair link data collection, and a total number of beams per antenna panel of the WD 22 to be used for beam pair link data collection. In some embodiments, the method also includes mapping each beam of the beams of the WD 22 to a UL-RS resource. In some embodiments, the mapping is according to an indication from the network node 16. In some embodiments, the method also includes indicating an uplink (UL) reference signal configuration indicating a mapping of a plurality of UL reference signals to a plurality of beam pair links.

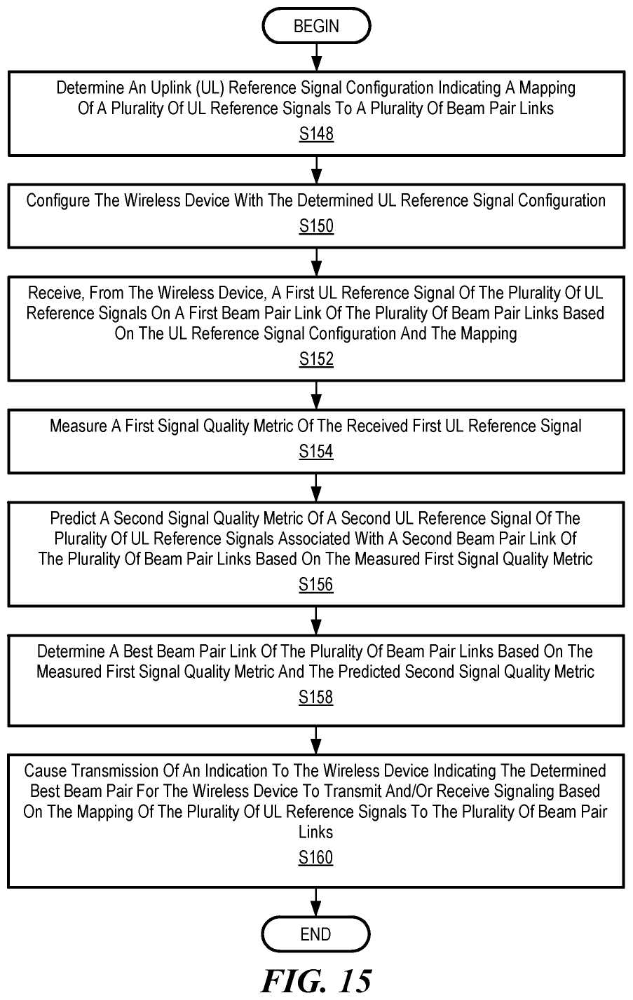

FIG. 15 is a flowchart of an example process in a network node 16 for network-sided inference of beam pair prediction using UL-RS. One or more blocks described herein may be performed by one or more elements of network node 16 such as by one or more of processing circuitry 68 (including the Network Node Beam Configuration Unit 33), processor 70, radio interface 62 and/or communication interface 60. Network node 16 is configured to determine (Block S148) an uplink (UL) reference signal configuration indicating a mapping of a plurality of UL reference signals to a plurality of beam pair links. Network node 16 is configured to configure (Block S150) the WD 22 with the determined UL reference signal configuration. Network node 16 is configured to receive (Block S152), from the WD 22, a first UL reference signal of the plurality of UL reference signals on a first beam pair link of the plurality of beam pair links based on the UL reference signal configuration and the mapping. Network node 16 is configured to measure (Block S154) a first signal quality metric of the received first UL reference signal. Network node 16 is configured to predict (Block S156) a second signal quality metric of a second UL reference signal of the plurality of UL reference signals associated with a second beam pair link of the plurality of beam pair links based on the measured first signal quality metric. Network node 16 is configured to determine (Block S158) a best beam pair link of the plurality of beam pair links based on the measured first signal quality metric and the predicted second signal quality metric. Network node 16 is configured to cause transmission (Block S160) of an indication to the WD 22 indicating the determined best beam pair for the WD 22 to transmit and/or receive signaling based on the mapping of the plurality of UL reference signals to the plurality of beam pair links.

In some embodiments, predicting of the second signal quality metric is based on a machine learning (ML) model, where the ML model receives at least one input including the measured first signal quality metric, positioning information associated with the WD 22, location information associated with the WD 22, and/or mobility information associated with the WD 22.

In some embodiments, the network node is further configured to train the ML model based on at least one measurement report associated with the first WD 22. In some embodiments, the network node 16 is further configured to receive, from the WD 22, a capability indication indicating at least one of a total number of antenna ports per beam and/or per panel 83, at least one beam which may be transmitted simultaneously with at least one panel 83, a mapping of WD beams to WD panels 83, a beam switching time, an antenna gain for at least one beam, a bandwidth for at least one beam, and a direction associated with at least one beam and/or at least one panel. The determining of the UL reference signal configuration may be based on the received capability indication.

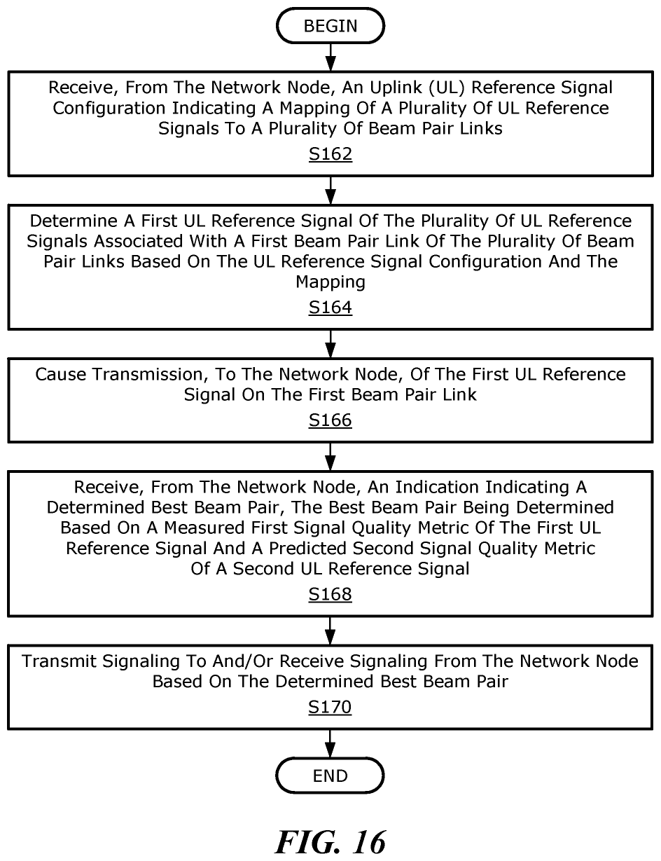

FIG. 16 is a flowchart of an example process in a WD 22 according to some embodiments of the present disclosure for network-sided inference of beam pair prediction using UL-RS. One or more blocks described herein may be performed by one or more elements of wireless device 22 such as by one or more of processing circuitry 84 (including the Wireless Device Beam Configuration Unit 35), processor 86, radio interface 82 and/or communication interface 60. Wireless device 22 such as via processing circuitry 84 and/or processor 86 and/or radio interface 82 is configured to receive, from the network node, an uplink (UL) reference signal configuration indicating a mapping of a plurality of UL reference signals to a plurality of beam pair links (Block S162). Wireless device 22 is configured to determine (Block S164) a first UL reference signal of the plurality of UL reference signals associated with a first beam pair link of the plurality of beam pair links based on the UL reference signal configuration and the mapping. Wireless device 22 is configured to cause transmission (Block S166), to the network node 16, of the first UL reference signal on the first beam pair link. Wireless device 22 is configured to receive (Block S168), from the network node 16, an indication indicating a determined best beam pair, the best beam pair being determined based on a measured first signal quality metric of the first UL reference signal and a predicted second signal quality metric of a second UL reference signal. Wireless device 22 is configured to at least one of transmit signaling to and/or receive signaling from (Block S170) the network node 16 based on the determined best beam pair.

In some embodiments, the predicted second signal quality metric is determined based on a machine learning (ML) model, where the ML model receives at least one input including the measured first signal quality metric, positioning information associated with the wireless device 22, location information associated with the wireless device 22, and/or mobility information associated with the wireless device 22. In some embodiments, the ML model is trained based on at least one measurement report associated with the first wireless device 22. In some embodiments, the wireless device 22 is further configured to determine a capability indication indicating at least one of a total number of antenna ports per beam and/or per panel 83, at least one beam which may be transmitted simultaneously with at least one panel 83, a mapping of wireless device beams to wireless device panels 83, a beam switching time, an antenna gain for at least one beam, a bandwidth for at least one beam, and a direction associated with at least one beam and/or at least one panel 83. Wireless device 22 is further configured to cause transmission of the capability indication to the network node 16, where receiving of the UL reference signal configuration is based on the transmitted capability indication.

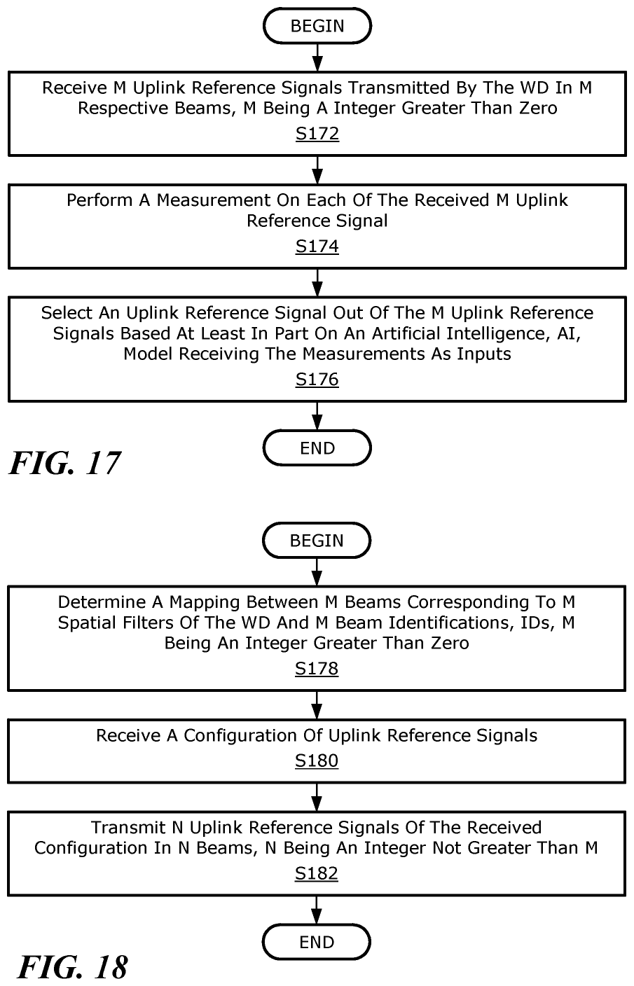

FIG. 17 is a flowchart of an example process in a network node 16 for network-sided inference of beam pair prediction using UL-RS. One or more blocks described herein may be performed by one or more elements of network node 16 such as by one or more of processing circuitry 68 (including the Network Node Beam Configuration Unit 33), processor 70, radio interface 62 and/or communication interface 60. Network node 16 is configured to receive (Block S172) M uplink reference signals transmitted by the WD in M respective beams, M being a integer greater than zero. The method also includes performing (Block S174) a measurement on each of the received M uplink reference signals. The method further includes selecting (Block S176) an uplink reference signal out of the M uplink reference signals based at least in part on an artificial intelligence, AI, model receiving the measurements as inputs.

According to this aspect, in some embodiments, the method includes sending an uplink reference signal identification, ID, to the WD 22, the uplink reference signal ID indicating the selected uplink reference signal. In some embodiments, the method includes configuring the WD 22 with a mapping between N beams and N beam identifications, IDs. In some embodiments, the method includes transmitting a triggering signal to trigger the WD 22 to transmit the M uplink reference signals. In some embodiments, the method includes receiving from the WD 22 an antenna configuration ID and a mapping between the antenna configuration ID and a beam ID. In some embodiments, the method includes receiving from the WD 22 an indication of at least one of a number of antenna ports per beam and a number antenna ports per antenna panel. In some embodiments, the method includes receiving from the WD 22 a mapping of beams to antenna panels of the WD 22. In some embodiments, the method includes receiving an indication of beams that may be transmitted simultaneously by the WD 22. In some embodiments, the method includes receiving from the WD 22 assistance information associated with transmission of the M beams, the assistance information including at least one of an antenna orientation, a WD position, velocity and direction, and non-line-of-sight information.

FIG. 18 is a flowchart of an example process in a WD 22 according to some embodiments of the present disclosure for network-sided inference of beam pair prediction using UL-RS. One or more blocks described herein may be performed by one or more elements of wireless device 22 such as by one or more of processing circuitry 84 (including the Wireless Device Beam Configuration Unit 35), processor 86, radio interface 82 and/or communication interface 60. Wireless device 22 such as via processing circuitry 84 and/or processor 86 and/or radio interface 82 is configured to determine (Block S178) a mapping between M beams corresponding to M spatial filters of the WD 22 and M beam identifications, IDs, M being an integer greater than zero. The method includes receiving (Block S180) a configuration of uplink reference signals. The method includes transmitting (Block S182) N uplink reference signals of the received configuration in N beams of the M beams, N being an integer not greater than M.

According to this aspect, in some embodiments, the N beams used to transmit the N uplink reference signals are indicated to the WD 22 by indicating N of M beam IDs. In some embodiments, a beam ID of the M beam IDs is an uplink reference signal ID. In some embodiments, the method includes receiving a selected beam ID indicating a beam of the WD 22 selected by the network node 16 from the M beams. In some embodiments, the selected beam ID is based at least in part on measurements on the N uplink reference signals. In some embodiments, the selected beam ID is determined by an artificial intelligence, AI, model. In some embodiments, the method includes at least one of transmitting and receiving control and data payloads on a beam to which the selected beam ID is mapped. In some embodiments, the determined mapping is obtained from the network node 16. In some embodiments, the method includes storing an uplink reference signal ID for each of the N uplink reference signals. In some embodiments, transmitting the N uplink reference signals is in response to a trigger received from the network node 16. In some embodiments, the method includes transmitting an antenna configuration ID and a mapping between the antenna configuration ID and a beam ID. In some embodiments, the method includes transmitting an indication of at least one of a number of antenna ports per beam and a number of antenna ports per antenna panel. In some embodiments, the method includes transmitting a mapping of beams to antenna panels of the WD 22. In some embodiments, the method includes transmitting an indication of beams that may be transmitted simultaneously by the WD 22. In some embodiments, the method includes associating uplink reference signal resources to different antenna panels of the WD 22. In some embodiments, the method includes transmitting assistance information associated with transmission of the N beams, the assistance information including at least one of an antenna orientation, a WD position, velocity and direction, and non-line-of-sight information.

Having described the general process flow of arrangements of the disclosure and having provided examples of hardware and software arrangements for implementing the processes and functions of the disclosure, the sections below provide details and examples of arrangements for sounding reference signal (SRS)-based collection to support beam pair prediction model training and network-sided inference of beam pair prediction using UL-RS.

Some embodiments of the present disclosure provide an AI/ML model for spatial domain beam prediction, e.g., a functionality or part of a functionality in a network node 16 (and/or core network 14 and/or host computer 24) that is related to spatial domain beam prediction, and which may be deployed/implemented/configured/defined in the network node 16 side.

As used herein, “network node side” may be used interchangeably with “network side” and may, for example, refer to one or more procedures/processing operations/etc. (e.g., AI/ML model training, prediction, measurement, etc.) occurring at a network node 16, core network 14, and/or host computer 24. Embodiments of the present disclosure also provide methods at the WD 22 for assisting/enabling the network node 16 (and/or core network 14 and/or host computer 24) to perform these actions/procedures/etc., such as determining measurement configuration, spatial domain beam configurations, prediction configurations/parameters, etc., requesting AI/ML model predictions, receiving indications according to AI/ML model output, and/or configuring/executing transmission, reception, beamforming, and/or measurement processes accordingly.

In some embodiments, an AI/ML model for spatial domain beam prediction may be defined as a feature or part of a feature that is related to spatial domain beam prediction and is implemented/supported in a network node 16. This network node 16 may be configured to indicate the feature version to another network node 16, e.g., a gNB. If the AI/ML model is updated, the feature version may be changed by the network node 16. The AI/ML model may be implemented by a neural network or other types of similar functions/algorithms.

An AI/ML-model for spatial domain beam prediction may correspond to a function which receives one or more inputs (e.g., channel measurements on a set of beam pair links) and provides as outcome one or more decision(s), estimation(s), or prediction(s) of a certain type (e.g., CSI for another set of beam pair links).

In describing some embodiments of the present disclosure, the terms “ML-model”, “AI-model”, “Model Inference”, “Model Inference function” may be used interchangeably. For example, an ML model or Model Inference may be a function that provides AI/ML model inference output (e.g., predictions or decisions), such as the prediction(s) of beam pair links (e.g., network node 16 beam, WD beam) according to the method. The Model inference function may also be responsible for data preparation (e.g., data pre-processing and cleaning, formatting, and/or transformation) based on Inference Data delivered by a Data Collection function. The output may correspond to the inference output of the AI/ML model produced by a Model Inference function. Some embodiments of the present disclosure may provide configurations for the “Model Inference function,” e.g., at the network node 16, as well as configurations for assistance information determined and transmitted from the WD 22 to network node 16 to provide inputs and/or parameters to the function.

In some embodiments of the present disclosure, the predictions may be spatial-domain predictions. For example, the input of the AL/ML model may correspond to receptions of UL RSs from the WD 22 at the network node 16 side, within the UL-RS transmission occasion from t0 to t0+T (or within a periodic UL-RS transmission occasion from t0+j*T to t0+ (j+1)*T, j=0, 1, . . . , where T is the duration of the UL-RS transmission occasion) for at least one WD 22 Tx beam and one network Rx beam, and the output of the AI/ML model includes one or more spatial-domain predicted measurements for beam pair links within the UL-RS transmission occasion from t0 to t0+T (and/or within a periodic UL-RS transmission occasion from t0+j*T to t0+ (j+1)*T, j=0, 1, . . . ,) for at least one beam. In some embodiments, the input to the AI/ML model may include one or more measurements and/or other types of input, e.g., information associated with signaling and/or WD 22 such as positioning/rotation/orientation, geographic coordinates, GPS position, etc. In describing some embodiments of the present disclosure, an “actor” (e.g., an “actor in the processing chain”) may refer to a function/sub-routine/method/algorithm/etc. that receives the output from the Model inference function and triggers and/or performs corresponding actions. The actor may trigger actions directed to other entities or to itself.

Some embodiments of the present disclosure provide methods and apparatuses for performing/providing inference of UL reference signal based network-sided beam pair prediction. For example, in some embodiments, a method is provided for configuring a WD 22 to transmit UL-RSs in a subset of WD beams for the network node 16 to perform radio measurements on the associated subset of beam pairs, and the measurements may be used as part of the input for network-sided beam pair prediction model inference to predict the top-k beam pairs (i.e., model inference output) from all candidate beam pairs. The network node 16 determines and/or causes transmission of signaling (e.g., control signaling/resources/information) to configure the WD 22 to apply the WD beam that is associated to the selected beam pair (where the beam pair selection is based on the model inference output) for transmitting/receiving data/signals. For example, the WD 22 may be configured with an UL reference signal configuration within a message, e.g., determined and/or transmitted by the network node 16. This message may, for example, be an RRCReconfiguration message (or an RRC Resume message, when the WD 22 transitions from RRC_INACTIVE), a MAC CE, etc. The UL reference signal configuration may include configurations/parameters of one or more UL reference signals associated with a subset of the WD beams, which may include fewer beams than the available WD beams (e.g., as reported according to a WD 22 capability message/indication, such as in a previous transmission by the WD 22 to the network node 16). The UL reference signals may, for example, be an SRS, e.g., as specified in SRS configuration information element (IE) in 3GPP TS 38.331. An UL reference signal may then be associated with a specific beam (spatial filter) of the WD 22. In some embodiments, the WD 22 further receives an indication of an association between UL-RS IDs and WD beams, such that a unique UL-RS ID may be mapped to one (or more) unique WD beam(s). The association (“UL-RS ID to WD beam”-mapping) may, for example, be indicated by the network node 16 using RRCReconfiguration message, a MAC CE, another control message/indication, etc. Based on receiving (and/or storing and retrieving, e.g., from memory 88) this association/mapping, the WD 22 may be able to determine from which WD beams (e.g., which spatial filter to apply) to transmit the UL reference signals configured in the UL reference signal configuration mapping. In some embodiments, the network node 16 may perform radio measurements on a subset of beam pairs that are associated to the configured UL-RS transmissions from the WD 22, and then may use the measurement(s) as part of the input for AI/ML model inference. Based on the model inference outcome, e.g., the predicted top-k beam pairs from all possible beam pairs between the WD 22 and network node 16, and/or other conditions (e.g., the predicted top-k beam pairs for other WDs 22), the network node 16 may determine/select one (or more) beam pair(s) out of the predicted top-k beam pairs for the WD 22 and sends a beam indicating message indicating the determined/selected beam pair(s) to the WD 22 so that the WD 22 may apply the determined/selected WD beam(s).

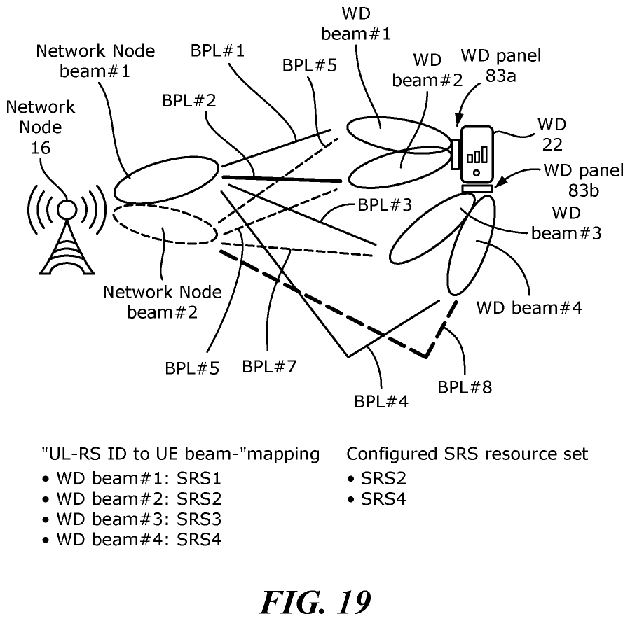

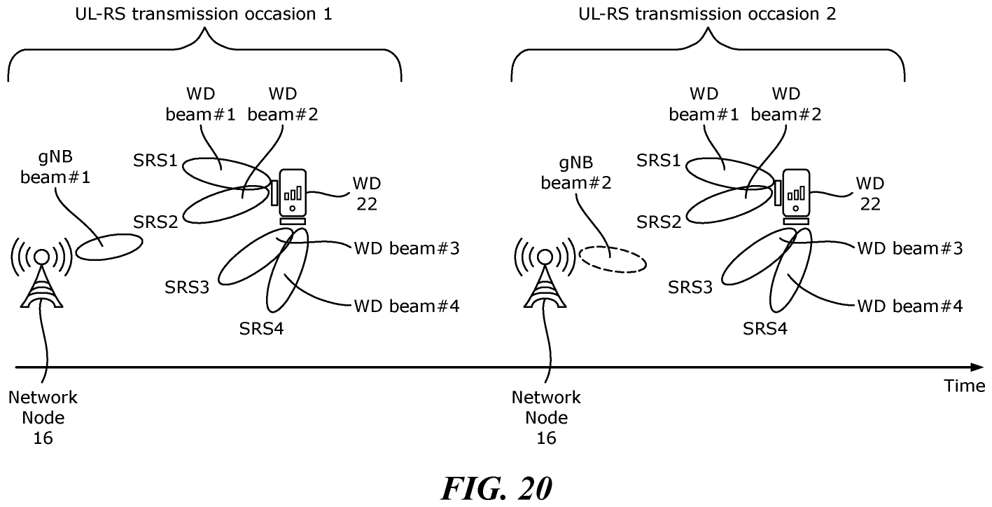

FIG. 19 illustrates an example schematic of beam pair links between a WD 22 and a network node 16 wherein an association between SRS resources and WD beams is configured, and the SRS resources may be configured for transmission for beam pair link predictions at the WD 22. In this example, the WD 22 is equipped with two WD panels 83a and 83b, where each WD panel 83 has two associated WD beams. Each WD beam may be associated with a unique “WD beam ID. In this example the WD 22 has been configured with 4 SRS resources, and where each SRS resource may be associated to one of the WD beams according to the “UL reference signal resource. Also, in this example the WD 22 has received an “UL-RS ID to WD beam”-mapping (or similar mapping, such as “UL-RS ID to WD beam”-mapping) indicating the association between UL-RS IDs and WD beams. Since the network node 16 in this case is equipped with two network node 16 beams, there are a total of 8 candidate beam pair links (BPL #1-BPL #8). This example illustrates an advantage of some embodiments of the present disclosure, in which only a subset of all the candidate beam pair links need to be sounded during an SRS transmission in each WD beam. FIGS. 20 and 2121 illustrate two examples of the method of the data collection of the beam pair links used. In this example, the WD 22 has been configured (and/or preconfigured) with SRS resource 2 (SRS2) and SRS resource 4 (SRS4), which are associated with WD beam #2 and WD beam #4, according to the “UL-RS ID to WD beam

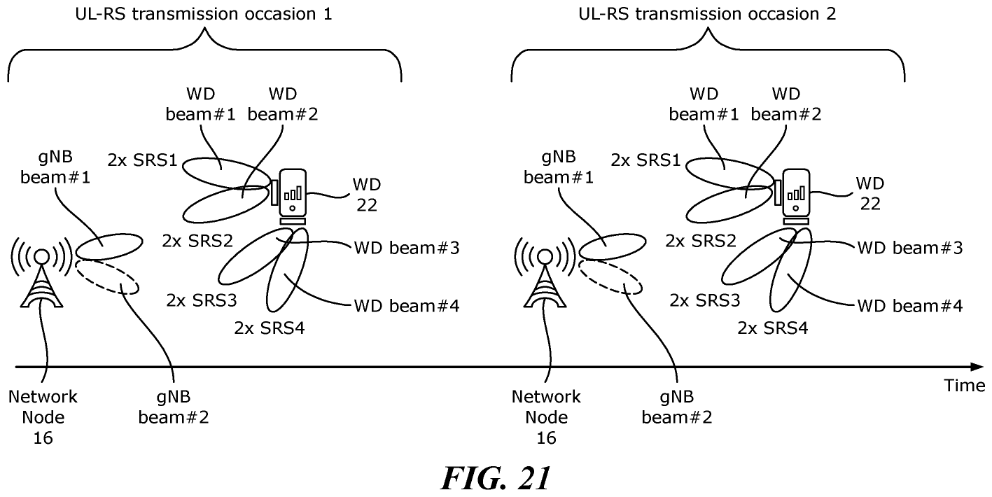

In FIG. 20, there may be no repetition factor for the SRS, which means that each WD beam (i.e., beam #s 1-4) may be only sounded once per SRS transmission occasion. In this case, the network node 16 may be equipped with analog beamforming architecture, the network node 16 may perform the measurements on multiple SRS transmission occasions and collect all data (i.e., the measurements of different beam pair links) for model training. In FIG. 21, each SRS resource may be configured with a repetition factor 2, which means that each SRS resource may be transmitted twice using the same WD beam, which allows the network node 16 to evaluate two candidate network node beams. In this way, more beam pair links may be evaluated during each UL-RS transmission occasion. For the two SRS resources, the network node 16 may evaluate 2 out of 8 beam pair links, which is illustrated with the thick lines in the figure. Based on measurements of these two beam pair links the network node 16 may predict the best beam pair link or k-best beam pair links out of all 8 candidate beam pair links and signal back the SRS ID corresponding to the associated WD beam of the predicted beam pair link. The WD 22 may then use that beam for transmitting/receiving data/signals. In this way the overhead signaling and latency are reduced during beam management procedures at mmWave and sub-terra Hz frequencies.

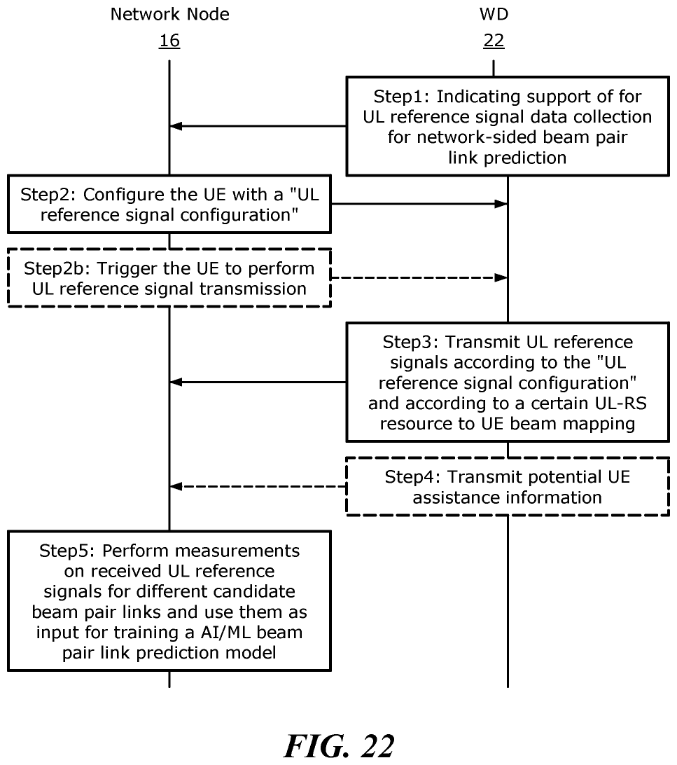

FIG. 22 illustrates an example of a method according to some embodiments of the present disclosure for inference of a beam pair link prediction AI/ML model. In the first step of this example, the WD 22 transmits SRS in a subset of the beam pair links (e.g., based on a configuration received from the network node 16 and/or stored in memory 88). The network node 16 receives the SRS in corresponding network node 16 beams and uses the AI-ML model (as implemented, e.g., in processing circuitry 84) to predict the best beam pair link. In the next step, the network node 16 indicates to the WD 22 which WD beam to use (e.g., based on the best predicted beam pair link), by signaling an SRS ID which is associated to a WD beam, e.g., through the “UL-RS ID to WD beam”-mapping or similar configuration indication/message.

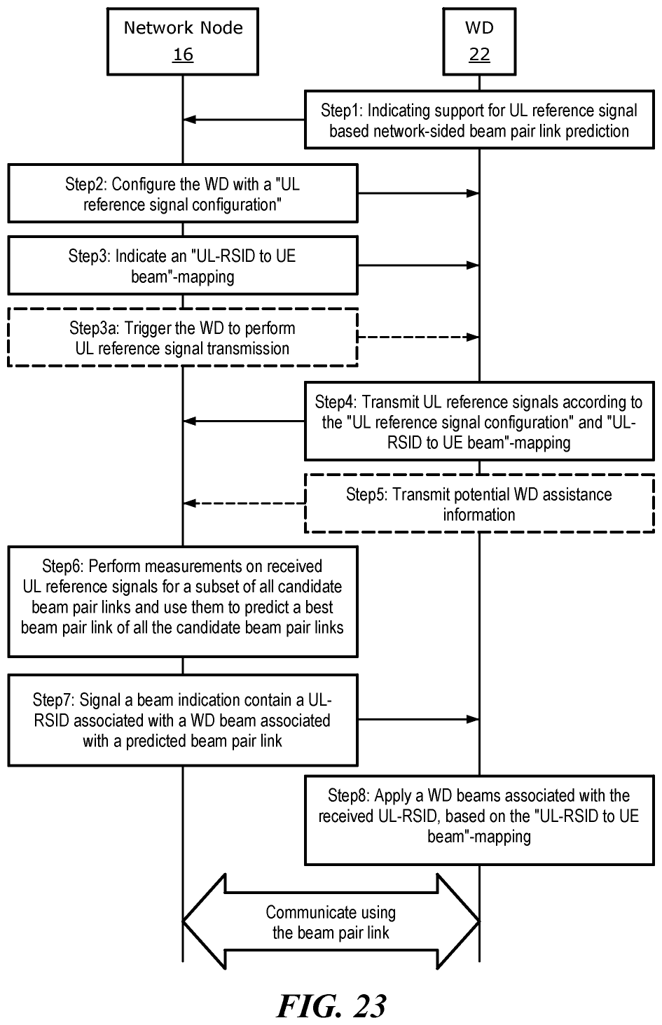

Referring to FIG. 23, in Step1 the WD 22 reports, for example during WD 22 capability signaling (e.g., “UE Capability Signaling”), support for UL reference signal based network-sided beam pair link prediction.

The WD 22 capability signaling may, for example, include one or more of the following information:
Total number of WD beams to use for beam pair link data collection;
Total number of WD panels to use for beam pair link data collection;
One single number of beams indicating the number of beams per panel to use for beam pair link data collection (assuming each panel has the same number of beams);
One single number of beams per indicated WD panel to use for beam pair link data collection;
Total number of antenna ports per WD beam/WD panel 83/WD 22;
Number of simultaneously transmitting beams/panels 83 (e.g., how many beams/panels 83 the WD 22 may transmit UL RS from simultaneously);
Information about which beams that belongs to which WD panel;
Information about which beams belongs to which WD panel 83;
Information about which beams/panels 83 that may be transmitted simultaneously;
Information about number of (antenna) ports that each WD beam may be associated with;
A “UE antenna/beam configuration ID” or similar WD 22 identifier associated with the WD 22 antenna configuration and/or beam configuration (including, for example, the association/mapping between a WD beam and a WD beam ID/WD beam ID);
   The “WD antenna/beam configuration ID” or similar identifier may be used as an input to the AI/ML model;
WD panel 83 switching time;
Antenna gain for respective WD beam;
Beamwidth for respective WD beam; and/or
Pointing directions for respective WD panel 83/WD beam.

Still referring to FIG. 23, in Step2, the network node 16 indicates the relevant UL-reference signal configurations for the beam pair link prediction in a message referred to as “UL reference signal configuration”. The “UL reference signal configuration” may, for example, include one or more of:
One or more UL-RS resource sets (e.g., SRS resource set);
One or more UL-RS resources (e.g., SRS resource);
A DL-RS resource configuration for 6G; and/or
“UE antenna/beam configuration ID” or similar identifier associated with a WD 22 antenna configuration and/or WD beam configuration and/or “UL-RS resource to WD beam”-mapping or similar mapping.

In Step 3, the network node 16 indicates a “UL-RS ID to WD beam”-mapping or similar mapping to the wireless device 22, that associates different UL-RS IDs with different wireless device 22 beams. In an optional Step 3a, the network node 16 triggers the wireless device 22 to perform UL reference signal transmission, e.g., based on the configuration and/or mapping.

In Step4, the WD 22 performs an UL-RS transmission occasion by transmitting the UL-RS resources in the associated WD beams, where the association between WD beams and UL-RS resource is based on the “UL-RS ID to WD beam”-mapping or similar mapping.

In the optional Step5, the WD 22 transmits additional WD 22 assistance information associated within the UL-RS transmission occasion, where the additional WD 22 assistance information may, for example, include one or more of:
WD 22 antenna rotation angle (e.g., in a global coordination system);
WD 22 position;
WD 22 antenna orientation;
WD 22 mobility info, e.g., WD 22 speed and/or a direction WD 22 is moving;
Which beams that are blocked by near-field objects (e.g., human body);
Which panels 83 that are blocked by near-field objects (e.g., human body);
Which beams that are expected to be blocked by far-field moving objects (e.g., vehicles, pedestrians, etc.);
Which panels 83 that are expected to be blocked by far-field moving objects (e.g., vehicles, pedestrians etc.); and/or
The “UL-RS resource to WD beam”-mapping or similar mapping has been changed from previous UL-RS transmission occasion.

Referring still to FIG. 23, in Step6, the network node 16 performs measurements on the transmitted UL-RS including potential network node 16 RX beam sweeps, to attain measurement data on a subset of all candidate beam pair links. The measurements may then be used to predict a preferred beam pair link from all (or a subset of) candidate beam pair links, for example, using an AI/ML model. The AI/ML model may be for beam pair prediction base on a certain design objective (e.g., spatial beam pair prediction or temporal beam pair prediction).

Collecting raw data at the network node 16 for multiple beam pair links may be performed in some embodiments. To design an AI/ML model for beam pair prediction with a certain optimization objective, the collected raw data may call for further processing to create the training data set (e.g., model input and model output). How to use the collected raw data to design an AI/ML model depends on the use case and its optimization objective.

It may be possible to reuse the collected raw data for training different AI/ML models for beam pair prediction, e.g., by using the collected raw data to create different training datasets according to the optimization objectives of different AI/ML models. For instance, if the network node 16 may collect raw measurement data and the associated identifiers of all beam pair links for multiple data collection instances and from multiple WDs 22. Then, the collected raw data may be used for training an AI/ML model to perform spatial domain beam pair prediction (e.g., predicting the top-k beam pairs out of all possible beam pairs based on measurements from only a subset of the beam pairs) by creating a training data sets that includes a list of subsets of beam pairs together with the corresponding channel measurements as model input, and an associated list of top-k beam pairs as model output. In this case, different AI/ML models may be trained for different values of k or/and different number of measured beam pairs in the subset. With a proper data processing, the collected raw data may also be used to create training data for design an AI/ML model to perform time-domain beam pair prediction (e.g., predicting the top-k beam pairs in a future time instance t2 based on the collected measurements of all beam pairs within a certain time window).

It may also be possible to reuse the collected raw data for training AI/ML models for other use cases, e.g., SRS based positioning and SRS based link adaptation, if the raw data may be processed to create the appropriate data sets to be used for training the model(s).

Referring still to FIG. 23, in Step7, the network node 16 signals a beam indication to the WD 22 associated with the predicted beam pair link. The beam indication is performed by signaling an UL-RS ID that is associated with the WD beam of the predicted beam pair link, where the association between the UL-RS ID and the WD beam is based on the “UL-RS ID to WD beam”-mapping or similar mapping.

In Step8, the WD 22 applies the indicated WD beam and use that for communicating with the network node 16.

In some embodiments, the network node 16 receives one of the configured UL reference signal(s) and determines which WD beam the WD 22 has used to transmit that UL RS. For example, if the network node 16 has configured the WD 22 with the mapping [(UL RS A, WD beam index 1); (WD RS B, WD beam index 2); (UL RS C, WD beam index 3)], the reception of UL RS B at the network indicates that it has been transmitted by the WD 22 with WD beam index 2, which enables network node 16 to measure the quality of a beam pair link, e.g., as the network node 16 may receive that UL RS in one or more of its network beams, e.g., network node 16 beam 1, network node 16 beam 2, etc.

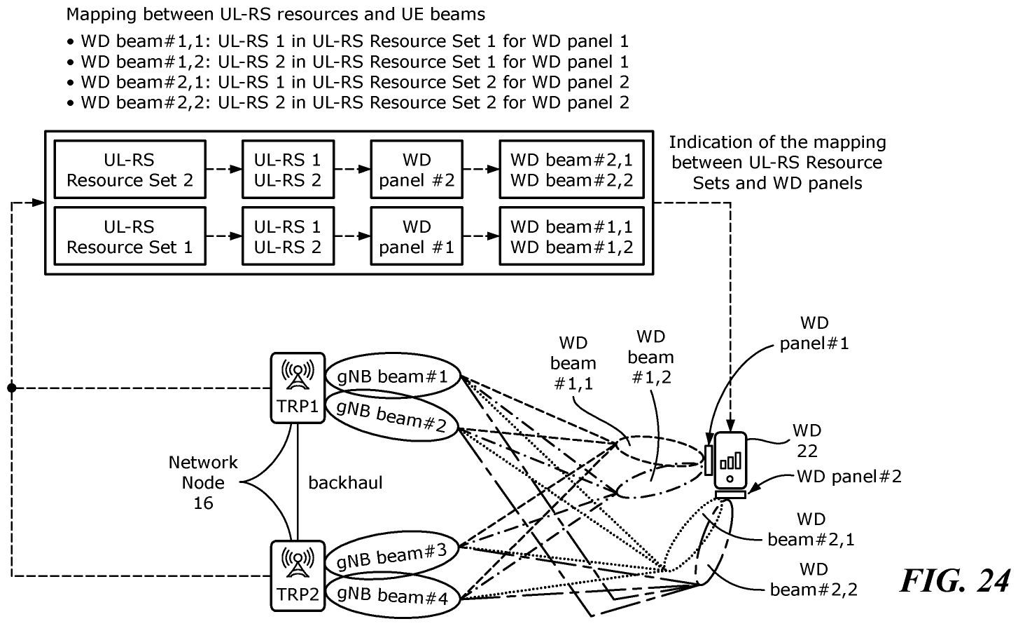

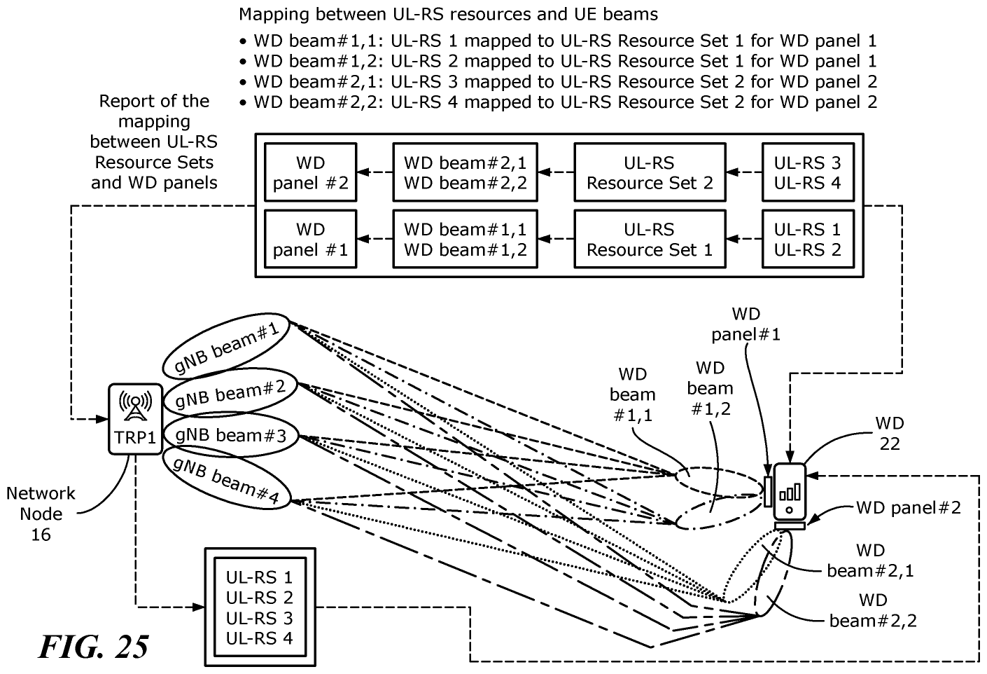

In some embodiments, the WD 22 transmits the UL reference signals (SRSs) according to the “UL reference signal configuration” and a mapping between UL-RS resources and WD beams, where the mapping may be determined (1) by the network node 16 and the network node 16 indicates the mapping to the WD 22, or (2) by the WD 22 and the WD 22 reports the mapping to the network node 16.
The network node 16 may determine the mapping between UL-RS resources and WD beams: In one embodiment, the network node 16 divides the UL-RS resources into N UL-RS resource sets, wherein each UL-RS resource set may be associated to one WD antenna panel, e.g., UL-RS resources in UL-RS resource set M may be associated to the beams from WD antenna panel m. One benefit is that the network node 16 may differentiate the measurement data collected from different panels at the WD 22. It is also good for the D-MIMO or multi-TRPs as the WD 22 does not know the UL-RSs are from which TRPs. So, the mapping determined by the network node 16 may reduce the signaling complexity. An example may be found in FIG. 24.
The WD 22 may determine the mapping between UL-RS resources and WD beams: In one embodiment, the WD 22 decides the mapping between the UL-RS resources into N UL-RS resource sets, wherein each UL-RS resource set may be associated to one WD antenna panel, e.g., UL-RS resources in UL-RS resource set M may be associated to the beams from WD antenna panel m. An example may be found in FIG. 25. The mapping information may be reported from the WD 22 to the network node 16 as a type of assistance information as shown in FIG. 25. Alternatively, the mapping may be identified by a WD antenna/beam configuration ID and the WD 22 reports only the WD antenna/beam configuration ID the network node 16.

### On the Usage of the Collected Raw Data for AI/ML-Based Beam Pair Prediction Model Training

An example of how to utilize the collected raw data to design/train/retrain an AI/ML model for spatial domain beam pair prediction is given below. In some embodiments, the WD 22 reports a capability indicating that it has a maximum number of WD beams (or spatial directions) which may be used. Then, the WD 22 receives from the network node 16 a first message (e.g., RRC Reconfiguration, RRC Resume) including an UL reference signal configuration with a number of UL RSs associated to all WD beams (maximum number of WD beams the WD 22 has reported). This is the data collection phase and the WD 22 receives a command to activate all beams i.e. the maximum number of beams i.e. WD 22 transmits UL RSs in all configured WD beams.

In a first time period/window (data collection and model training phase) the WD 22 has assisted the network node 16 by transmitting UL-RSs associated to its WD beams in all WD beams, and the network node 16 performs channel measurements on all beam pairs. The network node 16 collects the measurement data together with available assistance information of all possible beam pairs and uses these raw data to create a data set for training an AI/ML model for spatial domain beam prediction. The (re) trained AI/ML model may be then deployed at the network node side.

In a second time period/window (model inference phase), the network node 16 uses the deployed AI/ML model to predict a preferred beam pair link of a set A of beam pair links based on radio measurements of a set B of beam pair links, where Set B may be a subset of set A. The WD 22 receives a second message (e.g., another RRC Reconfiguration message or a MAC CE). Then, the WD 22 receives from the network an UL reference signal configuration with a number of UL RSs associated to fewer WD beams than the maximum number of WD beams. Based on the channel measurements of beam pairs for these fewer WD beams the WD 22 has reported, the network node 16 may determine one of the beams within the maximum number reported. Based on UL RS transmissions, the network node 16 may be able to perform beam pair link prediction using the deployed AI/ML model, possibly indicating a beam pair which may be not being used/measured during the inference phase. The network node 16 may be able to perform beam pair link prediction in fewer of these beams, as a result of the spatial-domain predictions of beam link pairs.

For example, assume that an AI/ML model has been trained based on the measurements on the 8 candidate BPLs shown in FIG. 19. Then, during inference, the WD 22 might be configured with an SRS transmission associated with only a subset of all 8 BPLs, for example only BPL #2 and BPL #7. Based on the measurements performed on BPL #2 and BPL #7, the AI/ML model at the network node 16 may determine the best BPL or k-best BPLs out of all 8 BPLs. In this way the overhead signaling and latency are reduced during beam management procedures at mmWave and sub-terra Hz frequencies.

To design an AI/ML model for the spatial beam prediction use case described above, the AI/ML model may be constructed with the following model input and model prediction output:
ML Model input: a subset BPL measurements out of all possible BPLs (i.e., Set B). The input training dataset may include a variety of BPL subsets. An example ML model input include:
   (a) The total number of BPLs available, N_{BPL}. In the example of FIG. 8, N_{BPL}=8;
   (b) The number of BPLs in Set B, N_{BPL, SetB}. For example, N_{BPL, SetB}={2, 3, 4} means that only measurements of 2 or 3 or 4 BPLs are used as ML model input; and/or
   (c) The channel measurements (e.g., L1-RSRP values) and the associated identifiers of the BPLs (e.g., Tx/Rx beam ID, WD panel ID, SRS resource ID, BPL ID or/and WD antenna/beam configuration ID) in the set B;
ML Model prediction: the k-best BPL associated to each Set B. Here k may be a predefined variable. For instance, k=2 means that the ML model may predict the best 2 BPLs out of the total of N_{BPL} available BPLs.

In order to construct a training dataset for the ML model described above, training data with labeled output may be provide to set up the supervised ML training. That is, for a list of N_{BPL, SetB} ML input (i.e., X for ML training), the k-best BPLs need to be identified and provided as expected ML output (i.e., Y for ML training) in the training dataset. Thus, in the data preparation/processing phase, a dedicated labeler functionality may be constructed. For the case where the network node 16 collects the raw data of all candidate BPLs (e.g., the example shown in FIG. 19) for each measurement instance, a list of ML model input and model output may be created by the network node 16. Alternatively, if the network node 16 does not have the raw data of all possible BPLs, the labeler functionality may be fulfilled by a legacy method (i.e., non-ML method) which has been implemented to identify the k-best BPL. For example, the labeler functionality has a set of measurements of N_{BPL,labeler} BPLs as input, and generates k-best BPL as output. Typically, N_{BPL}>=N_{BPL,labeler}>N_{BPL, meas}, i.e., the labeler function works offline and has more BPL measurements than the ML model to estimate (i.e., label) the best k BPLs. It may be noted that for a given pair of {a set B of BPL measurements, k-best BPL}, the N_{BPL,labeler} BPL measurements provided to the labeler and the N_{BPL, meas} measurements provided as ML model input may come from the same measurement instance.

In some embodiments, a labeler function may be implemented to provide k-best BPLs based on network node measurements of WD RS transmission. The output of the labeler provides ideal ML prediction output Y, which may be saved together with the measurements (i.e., ML model input X). Each {X, Y} may be one entry for the raw training dataset.

In some embodiments, the raw training dataset may be further processed by one or more of the following steps in order to prepare the training dataset for ML model training:
Data formatting. For example, this ensures that data collected from a variety of WDs 22, network nodes 16, and wireless link configurations use the same data format. Here the wireless link configuration includes carrier frequency, SCS, bandwidths, bands and band combinations, carrier aggregation, WD antenna configurations (e.g., antenna ports, antenna panels), network node antenna configuration, etc.;
Data transformation. For example, the ML input data may be transformed by scaling, normalization, clipping, bucketizing/binning etc. For the k-best BPL problem, the data may be SINR measurement of SRS ports, and the SINR measurements may be scaled and normalized to the desired ML model input value range; and/or
Feature engineering. For example, it needs to be decided what kind of data are most useful for generating accurate BPL predictions (i.e., features with the best predictive power). For example, it needs to be decided which of these possible features are most useful to include as ML input: carrier frequency, subcarrier spacing (SCS), WD antenna array configuration (e.g., cross polarization, antenna element distance, WD panel separation), network node antenna array configuration, etc.

After the data processing steps above, the raw training data may be validated and used as training dataset for training the ML model.

### On Triggering Events for Data Collection

In some embodiments, the data collection maybe initiated by the network node 16 based on that the network node 16 does not have AI/ML model at all, and/or the current AI/ML model may be not trained based on the current WD, and/or that the network node 16 has identified that the beam pair link prediction may not be functioning good enough e.g., upon detecting that the performance of the spatial-domain beam pair link prediction is poor or/and below an acceptable level. Other events which may trigger the network node 16 to configure the WD to perform the transmission of assistance information (UL RSs) for assisting the network node 16 to perform data collection are the following:
When the WD 22 transitions to RRC_CONNECTED in a cell e.g., from RRC IDLE or RRC_INACTIVE;
When the WD 22 is attaching to the network node 16;
Based on WD 22 battery level information, for example only configure data collection for WDs 22 with high battery level;
When the network node 16 experiences low traffic, for example during nighttime; and/or
When the WD 22 or the network node 16 detects a degradation in the performance of the AI/ML model providing spatial domain predictions.

In some embodiments, when the network node 16 triggers a handover and/or other reconfiguration with sync, data collection may also be triggered, i.e., the network node 16 configures the WD 22 to provide the assistance information (UL RSs). The target network node 16 in a handover preparation configures the WD 22 for providing the assistance information for data collection for AI/ML model training.

### Association Between Beam Pair Links and Serving Cells

In some embodiments, the WD 22 reports a capability indicating that it has a maximum number of WD beams (or spatial directions) which may be used. Then, it receives from the network node 16 an UL reference signal configuration with a number of UL RSs associated to all WD beams (maximum number of WD beams the WD 22 has reported). However, the WD 22 receives a command to only activate a subset of the maximum number of beams at the time. The network node 16 may determine one of the beams within the maximum number reported, based on UL RS transmissions in fewer of these beams, as a result of the spatial-domain predictions of beam link pairs. On the other hand, the network node 16 may configure the UL RSs for all WD beams, and respective mapping(s), because the WD 22 may move around and the network node 16 may determine to change which UL RSs are to be transmitted (even though there may still be fewer than all transmitted).

In some embodiments, the network node 16 performs spatial-domain beam pair link prediction, including predicting the quality of a first beam pair link (network node 16 beam X1, WD beam Y1) based on the reception of a second beam pair link (network node 16 beam X2, WD beam Y2).

In some embodiments, the predicted quality of a beam pair link includes the estimate or prediction of a received signal power (and/or SINR and/or other measurements) in a first beam pair link at a time instance and/or time interval, without the network node 16 having received a signal from the WD 22 in that first beam pair link at that time instance and/or time interval.

Not receiving in a beam pair link may include not receiving an UL RS in the same network Rx beam transmitted by the associated WD 22 Tx beam for that beam pair link. In one example, the predicted beam pair link may be (network node 16 beam X2, WD beam Y2) for a time instance or time interval, even if the network node 16 has not received at the corresponding measurement time instance or interval an UL RS signal in the network node 16 Rx beam X2 transmitted by the WD 22 using Tx beam Y2.

However, that does not preclude:
the reception by the network of an UL RS in Rx beam X2, with the transmitted UL RS by the WD 22 in another beam which is not beam Y2 (i.e., another beam pair link). According to this embodiment, the reception of an UL RS in network node 16 beam X2 may be used as input to possibly generate a prediction (i.e., ML model output) equal to the beam pair link (network node 16 beam X2, WD beam Y2) even if the WD 22 has not transmitted in beam Y2 during the time instance (or time period) that the network performs measurement for the purpose of ML prediction. This ML model setup enables the transmissions of fewer UL RSs in the multiple WD 22 Tx beams for providing ML model input, without reducing the ensemble of possible ML model output;
the reception by the network node 16 of an UL RS transmitted by the WD 22 in Tx beam Y2, with the reception at the network node 16 being in another Rx beam which is not X2 (i.e., another beam pair link). This may allow, for example, fewer UL RS transmissions at the WD 22, for that particular Tx beam, as network node 16 would not need to sweep its entire set of Rx beams.

According to some embodiments, an UL RS received in network node 16 beam X2 and transmitted by a WD 22 Tx beam Y2 (a first beam pair link) may be used by the network as input, or be used to generate input, to an AI/ML model capable of spatial-domain prediction of beam pair links to produce as a possible output a prediction of a second beam pair link which may be associated to the same network node 16 beam X2, while not associated to WD 22 Tx beam Y2.

According to some embodiments, an UL RS received in network node 16 beam X2 and transmitted by a WD 22 Tx beam Y2 (a first beam pair link) may be used by the network as input to an AI/ML model capable of spatial-domain prediction of beam link pairs to produce as a possible output a second beam pair link which may be associated to the WD 22 Tx beam Y2, while not associated to the network node 16 Rx beam X2.

In some embodiments, the first beam pair link differs from the second beam pair link in the Rx NW beam.

In some embodiments, the first beam pair link (network node 16 beam X1, WD beam Y1) differs from the second beam pair link (network node 16 beam X2, WD beam Y2) because network node 16 beam X1 is different than network node 16 beam X2. However, it is allowed that the WD beam Y1=WD beam Y2. This may mean that the network node 16 predicts the quality of the first beam pair link (network node 16 beam X1, WD beam Y1) based on the reception in another beam pair link, having different Rx beam at network, but based on the transmission from the WD 22 in the corresponding Tx beam of the beam pair link to be predicted, in this example, WD beam Y1. In other words, the WD 22 transmits an UL RS using WD beam Y2, network node 16 receives beam X2, and based on that, the AI/ML model in network node 16 predicts (i.e., AI/ML model output indicates) the beam pair (network node 16 beam X1, WD beam Y1) as one of best-k beam link pairs.

In some embodiments, the first beam pair link (network node 16 beam X1, WD beam Y1) differs from the second beam pair link (network node 16 beam X2, WD beam Y2) because WD beam Y1 is different than WD beam Y2. However, it is allowed that the network node 16 beam X1=network node 16 beam X2. This means that the network node 16 predicts the quality of the first beam pair link (network node 16 beam X1, WD beam Y1) based on the reception in another beam pair link, having the same Rx beam at network node 16, but based on different transmissions from the WD 22, i.e., in different Tx beam of the beam pair link to be predicted, in this example, WD beam Y2. In other words, the WD 22 transmits an UL RS using WD beam Y2, network node 16 receives beam X1, and based on that, the AI/ML model in network predicts (i.e., AI/ML model output indicates) the beam pair (network node 16 beam X1, WD beam Y1) as one of best-k beam link pairs.

In some embodiments, the first beam pair link (network node 16 beam X1, WD beam Y1) differs from the second beam pair link (network node 16 beam X2, WD beam Y2) because both WD beam Y1 is different than WD beam Y2 and network node 16 beam X1 is different than network node 16 beam X2. This means that the AI/ML model in network predicts (i.e., AI/ML model output indicates) the first beam pair link (network node 16 beam X1, WD beam Y1) as one of best-k beam link pairs, where the prediction is based on (i.e., AI/ML model input comprises) the reception in another beam pair link, having different Rx beam at network node 16, and different transmissions from the WD 22, i.e., in different Tx beam of the beam pair link to be predicted.

Note: there may be different network capabilities related to these three example possibilities above.

In some embodiments, the network node 16 transmits a beam indication message to the WD 22, where the message contains an indication of a first UL-RS (e.g., UL-RS ID), indicating to the WD 22 to update the WD beam (spatial filter and/or spatial direction in which the WD 22 transmits signals to the network) based on the indication of the UL-RS and the previously attained mapping between a WD beam and an UL reference signal. The indication of the UL-RS (which is also an indication of a WD beam) from the network is derived based on the spatial-domain predictions of beam pair links.

In some embodiments, the network node 16 indicates to the WD 22 an UL RS ID (associated to a WD beam) in response to the reception from the WD 22 of a different UL RS (associated to a different WD beam, and having a different UL RS ID). This means that based on a second WD beam (which refers to a second beam pair link) the network node 16 has predicted a first beam pair link having a different WD beam, which is what is being indicated.

In some embodiments, the WD 22 receives a beam indication message from the network, the message containing an indication of a first UL-RS (e.g., UL-RS ID), based on which the WD 22 updates the WD beam (spatial filter and/or spatial direction in which the WD 22 transmits signals to the network), also based on the previously attained mapping between a WD beam and an UL reference signal, wherein the indication of the UL-RS (which is also an indication of a WD beam) from the network is derived based on the spatial-domain predictions of beam pair links.

In some embodiments, the WD 22 is indicated an UL RS ID (associated to a WD beam) in response to the transmission from the WD 22 of a different UL RS (associated to a different WD beam and having a different UL RS ID). This means that based on a second WD beam (which refers to a second beam pair link) the network has predicted a first beam pair link having a different WD beam, which is what is being indicated.

In some embodiments, the first beam pair link and the second beam pair link are associated with the same bandwidth parts belonging to a same serving cell 18. Alternatively, the beam pair links are associated with different bandwidth parts, which may or may not belong to different serving cells 18.

In some embodiments, the first beam pair link and the second beam pair link are associated to the same serving cell 18, wherein which is the serving cell 18 the WD 22 is configured with, e.g., PCell, Pscell, SCell of the MCG, SCell of the SCG.

In some embodiments, the WD 22 transmits on UL RS for a first serving cell 18 and receives a WD beam indication (e.g., associated UL RS ID or a WD beam ID) of the same serving cell. This implies that the network node 16 has performed a spatial-domain prediction of a beam link pair of a serving cell, based on an UL RS transmission on the same serving cell.

In some embodiments, the first beam pair link and the second beam pair link are associated to different serving cell 18, wherein a serving cell may be a PCell while the other an SCell of the MCG, wherein these serving cells 18 are from the same cell group.

In some embodiments, the WD 22 transmits on UL RS for a first serving cell and receives a WD beam indication (e.g., associated UL RS ID or a WD beam ID) of a second serving cell. This implies that the network node 16 has performed a spatial-domain prediction of a beam link pair of the second cell, based on an UL RS transmission on the first serving cell.

In some embodiments, in data collection phase, the UL RS transmissions are associated to multiple serving cells the WD 22 may be configured with. Thus, the WD 22 receives sets of UL RS configuration(s), wherein a set may be associated to the WD Beams, and to a serving cell (i.e., if the WD 22 may be configured with multiple serving cells, the WD 22 receives multiple UL RS configuration(s) defined according to the method. And, even though the WD beams are the same (e.g., same identifiers), for the different sets, the UL RS transmissions would be in different serving frequencies, in different UL channels, and possibly having different UL RS IDs, and configured in different Serving Cell Configuration(s).

In some embodiments, the WD 22 transmits in a first set of WD beams a set of UL-RSs, wherein each UL RS is associated to one of the WD beams in the set, wherein these are transmitted with a first periodicity and in a first time period (e.g., model training); and, the WD 22 transmits in a subset of the first set of WD beams a subset of the UL-RSs in a second time period (e.g., inference after model retraining). The subset may be transmitted in an aperiodic manner (i.e., one-time triggered) or a periodic manner (either semi-persistently or periodically). If the subset is transmitted in a periodic manner, in some embodiments, they are transmitted with a second periodicity which is longer than the first periodicity.

In some embodiments, the WD 22 transmits the first set of WD beams enabling the network to verify the performance of beam pair link predictions.

In some embodiments, the WD 22 transmits the first set of WD beams enabling the network to perform online training and/or re-training of the AI/ML model deployed for performing spatial domain prediction(s) of beam link pairs.

In some embodiments, the WD 22 transmits the subset of WD beams enabling the network to perform the spatial domain prediction(s) of beam link pairs.

In some embodiments, the message the WD 22 receives from the network include the UL reference signal configuration and/or the indication of the mapping between a WD beam and an UL reference signal, based on which the WD 22 transmits UL RSs in one or more WD beams enabling the network to inferences of beam pair links, may correspond to an RRC Reconfiguration message (e.g., RRCReconfiguration), received when the WD 22 transitions to RRC_CONNECTED (or other form of Connected state) and/or after the WD 22 reports a capability to the network indicating support for UL reference signal based network-sided beam pair link prediction. The message may correspond to an RRC Resume message (e.g., RRCResume), received when the WD 22 transitions RRC_CONNECTED from RRC_INACTIVE, generated by the network after the network retrieves that capability.

In some embodiments, the UL-RS resources are allocated into N UL-RS resource sets, and where each UL-RS resource set is associated with one WD 22 antenna panel 83 and each UL-RS resource is associated with one WD beam. The network node 16 may predict one or more beam pair links in the same or different WD panels 83 based on one or more different beam pair links from the same or different WD panels 83. In the following embodiments, assume that WD 22 has 3 panels 83 where each panel 83 at the WD 22 has 2 beams. For simplicity, in some embodiments, the network node 16 may predict only one beam pair link (network node 16 beam X0, WD beam Y0) based on the measurement of 2 different UL reference signals, i.e., 2 measured beam pair links {(network node 16 beam X1, WD beam Y1), (network node 16 beam X2, WD beam Y2)}.

In some embodiments, the predicted WD beam (i.e., Y0) of the predicted beam pair link (network node 16 beam X0, WD beam Y0) and the measured WD beams (i.e., Y1 and Y2) of the measured beam pair links {(network node 16 beam X1, WD beam Y1), (network node 16 beam X2, WD beam Y2)} belong to the same WD panel 83 (one of WD panel 83 {0,1,2}, for example:
WD beam Y0, WD beam Y1, WD beam Y2 are all in the same WD panel 83 (one of WD panel 83s {0,1,2});
WD beam {Y0, Y1, Y2} belongs to the WD panel 83 {0,0,0}, respectively;
WD beam {Y0, Y1, Y2} belongs to the WD panel 83 {1,1,1}, respectively;
WD beam {Y0, Y1, Y2} belongs to the WD panel 83 {2,2,2}, respectively.

In some embodiments, the predicted WD beam (i.e., Y0) of the predicted beam pair link (network node 16 beam X0, WD beam Y0) and the measured WD beams (i.e., Y1 and Y2) of the measured beam pair links {(network node 16 beam X1, WD beam Y1), (network node 16 beam X2, WD beam Y2)} belong to the different WD panel 83.

In some embodiments, the predicted WD beam (i.e., Y0) of the predicted beam pair link and the measured WD beams (i.e., Y1 and Y2) of the measured beam pair links may be in different WD panels 83, where WD beams of the measured beam pair links (i.e., Y1 and Y2) are in the same panel 83, for example:
WD beam {Y0, Y1, Y2} belongs to the WD panel 83 {0,1,1}, respectively;
WD beam {Y0, Y1, Y2} belongs to the WD panel 83 {0,2,2}, respectively;
WD beam {Y0, Y1, Y2} belongs to the WD panel 83 {1,0,0}, respectively;
WD beam {Y0, Y1, Y2} belongs to the WD panel 83 {1,2,2}, respectively;
WD beam {Y0, Y1, Y2} belongs to the WD panel 83 {2,0,0}, respectively; and
WD beam {Y0, Y1, Y2} belongs to the WD panel 83 {2,1,1}, respectively.

In some embodiments, the predicted WD beam (i.e., Y0) of the predicted beam pair link and the measured WD beams (i.e., Y1 and Y2) of the measured beam pair links may be in different WD panels 83, where WD beams of the measured beam pair links (i.e., Y1 and Y2) are in the different WD panel 83, for example:
WD beam {Y0, Y1, Y2} belongs to WD panel 83 {0,0,1}, respectively;
WD beam {Y0, Y1, Y2} belongs to WD panel 83 {0,0,2}, respectively;
WD beam {Y0, Y1, Y2} belongs to WD panel 83 {0,1,0}, respectively;
WD beam {Y0, Y1, Y2} belongs to WD panel 83 {0,1,2}, respectively;
WD beam {Y0, Y1, Y2} belongs to WD panel 83 {0,2,0}, respectively;
WD beam {Y0, Y1, Y2} belongs to WD panel 83 {0,2,1}, respectively;
WD beam {Y0, Y1, Y2} belongs to WD panel 83 {1,0,1}, respectively;
WD beam {Y0, Y1, Y2} belongs to WD panel 83 {1,0,2}, respectively;
WD beam {Y0, Y1, Y2} belongs to WD panel 83 {1,1,0}, respectively;
WD beam {Y0, Y1, Y2} belongs to WD panel 83 {1, 1,2}, respectively;
WD beam {Y0, Y1, Y2} belongs to WD panel 83 {1,2,0}, respectively;
WD beam {Y0, Y1, Y2} belongs to WD panel 83 {1,2,1}, respectively;
WD beam {Y0, Y1, Y2} belongs to WD panel 83 {2,0,1}, respectively;
WD beam {Y0, Y1, Y2} belongs to WD panel 83 {2,0,2}, respectively;
WD beam {Y0, Y1, Y2} belongs to WD panel 83 {2,1,0}, respectively;
WD beam {Y0, Y1, Y2} belongs to WD panel 83 {2,1,2}, respectively;
WD beam {Y0, Y1, Y2} belongs to WD panel 83 {2,2,0}, respectively; and
WD beam {Y0, Y1, Y2} belongs to WD panel 83 {2,2,1}, respectively.

Thus, in some embodiments, each UL-RS resource set may be associated with one WD panel 83. Therefore, in some embodiments, the WD panel 83 may be replaced by the UL resource set for some or all of the above cases.

Alternatively, in some embodiments, the UL-RS resources are allocated to N UL-RS resource sets, where the UL-RS resources in one resource set may be associated with different WD 22 antenna panels 83. For example, two UL-RS resources, each corresponding to one of two antenna panels 83: UL-RS resource 1 from panel 83-1, UL-RS resource 2 from panel 83-2, for example:
UL-RS resource set 1 comprises: UL-RS resource 1 and 2;
UL-RS resource set 2 comprises: UL-RS resource 1.

This may enable the WD 22 to transmit from two panels 83 if configured to use UL-RS resource set 1. This may be necessary/desirable, for example, in order to reach two different TRPs at the network node 16 side, and/or to achieve high diversity gain. The performance gain comes at the cost of antenna panel 83 switching overhead and signaling overhead (e.g., extra DCI bits when scheduling PUSCH transmission).

On the other hand, the WD 22 may be configured to use UL-RS resource set 2 (thus stay with a single panel 83) when the transmission does not need the diversity gain. This may provide the WD 22 with a low overhead mode when the demand on data transmission reliability is not high.

Some examples include:

Example X1. A method in a User Equipment, e.g., wireless device 22, for collecting data at a network node 16 based on UL reference signals, where the data may be used at the network node 16 for training an AI/ML model for predicting one or multiple beam pair links between the network node 16 and the wireless device 22.

Example X2. A method in a wireless device 22 for sending UL reference signal for network-sided beam pair link prediction, the method comprising one or more of the following:
a. receiving a message containing a field UL reference signal configuration, wherein the UL reference signal configuration, configures N UL reference signal resources;
b. receiving a message with a “UL-RS ID to WD beam”-mapping indicating the association between M UL reference signal identifiers (UL-RS IDs) and M WD beams (spatial filters);
c. (Optional) receiving a trigger message to transmit an UL-RS transmission occasion according to the UL reference signal configuration;
d. perform an UL-RS transmission occasion (i.e., transmit the UL reference signals configured in the UL reference signal configuration);
e. (Optional) Provide the network with WD assistance information in association with the UL-RS transmission occasion;
f. receiving a beam indication message containing an indication of a selected UL-RS;
g. based on the indicated association (1b) between UL reference signal identifiers (UL-RS IDs) and wireless device 22 beams (spatial filters), apply the beam (spatial filter) associated with the selected UL-RS;
h. use the wireless device 22 beam (spatial filter) for transmitting and/or receiving control and data payloads.

Example X3. The method of Example X2, wherein the wireless device 22 sends a message to the network node indicating support for UL reference signal-based network-sided beam pair link prediction, the message may in addition indicate one or more of the following:
a. Total number of WD beams to use for beam pair link data collection;
b. Total number of WD panels to use for beam pair link data collection;
c. One single number of beams indicating the number of beams per panel to use for beam pair link data collection (assuming each panel has the same number of beams);
d. One single number of beams per indicated WD panel to use for beam pair link data collection;
e. Total number of antenna ports per wireless device beam/wireless device panel 83/wireless device 22;
f. Number of simultaneously transmitting beams/panels 83 (i.e. how many beams/panels 83 the wireless device 22 may transmit UL RS from simultaneously);
g. Information about which beams belong to which wireless device panel 83, if the wireless device 22 is equipped with multiple panels 83 for transmission and/or reception;
h. Information about which beams/panels 83 that may be transmitted simultaneously, if simultaneous transmission is supported by the wireless device 22;
i. A “WD antenna/beam configuration ID” associated with the WD's antenna configuration and/or beam configuration (including the association between a WD beam and a WD beam ID):
j. The “WD antenna/beam configuration ID” may be used as input to the AI/ML model;
k. WD panel 83 switching time, if the wireless device 22 is equipped with multiple panels 83 for transmission;
l. Antenna gain for respective wireless device 22 beam;
m. Beamwidth for respective wireless device 22 beam; and
n. Pointing directions for respective wireless device panel 83/wireless device 22 beam.

Example X4. The method of any one of Examples X2 and X3, wherein each WD beam is associated with a unique WD beam ID, and where each UL-RS resource is associated with a unique UL-RS ID.

Example X5. The method of Example X4, wherein the “UL-RS ID to WD beam”-mapping is signaled using WD beam ID and UL-RS ID.

Example X5a. The method of any of Examples X1 to X4, and where the WD 22 determines a pairwise mapping between a WD beam and an UL-RS resource such that the mapping is associated with a “WD antenna/beam configuration ID”.

Example X5b. The method of any of Examples X1 to X3, and where the WD 22 receives an indication from the network on how to associate an UL-RS resource with a WD beam (spatial filter); and where the indication is signaled using WD beam ID and UL-RS ID.

Example X6. “(where a certain “UE antenna/beam configuration ID” is associated with a certain UL-RS resource ID to wireless device 22 beam mapping).

Example X7: The method of any one of Examples X1-X5, wherein N number of UL reference signal resources configured in UL reference signal configuration is smaller than the M number of UL-RS IDs and M wireless device 22 beams indicated in “UL-RS ID to WD beam”-mapping (i.e. N is smaller than M).

Example X8. The method of Example X1, wherein the wireless device 22 transmits the UL reference signal resources configured in the UL reference signal configuration during one UL-RS transmission occasion.

Example X9. The method of Example X8, wherein the wireless device 22 transmits the UL reference signal resources in WD beams according to the “UL-RS ID to WD beam”-mapping.

Example X10. The method of Example X9, wherein the wireless device 22 performs a second UL-RS transmission occasion, and where the wireless device 22 transmits the UL reference signal resources in wireless device 22 beams according to the “UL-RS ID to WD beam”-mapping again.

Example X11. The method of any one of Examples X1 and X2, wherein the number of ports for a UL-RS resource is equal to the number of antenna ports for the associated wireless device 22 beam

Example X12. The method of Example X1, wherein the UL-RS resources are allocated into one or more UL-RS resource sets.

Example X13. The method of Example X12, wherein a “UL-RS usage” is configured per UL-RS resource set, and where the “UL-RS usage” indicates that the UL-RS resources associated with that UL-RS resource set is used for inference of network-sided beam pair link prediction (and where the usage is potentially shared with other types of UL-RS usages, for example the usage ‘antennaSwitching’, ‘beamManagement’ etc. as specified in SRS config IE).

Example X14. The method of Example X13, wherein the UL-RS resources are divided into N UL-RS resource sets, and where each UL-RS resource set is associated with one wireless device panel 83

Example X14a. The method of Example 14, and where the UL-RS resources are divided into N UL-RS resource sets, and where each UL-RS resource set is associated with one TRP if multi-TRPs are employed at the network side

Example X14b. The method of Example 14, and where the UL-RS resources are divided into N UL-RS resource sets, and where each UL-RS resource set is associated with one pair of one TRP and one WD panel if multi-TRPs are employed at the network side.

Example X14c. The method of any of Examples X14, X15 and X16, wherein there is a gap period configured between different UL-RS resource sets taking the reported wireless device panel 83 switching time into account.

Example X15. The method of Example X13, wherein the wireless device 22 has wireless device 22 beams of different beamwidths and where different UL-RS resource sets contains beams of different wireless device 22 beam widths.

Example X16. The method of Example X1, wherein the wireless device 22 transmits WD assistance information to the network node in association with an UL-RS transmission occasion, where the WD assistance information may contain one or more of:
i. Wireless device 22 antenna rotation angle;
j. Wireless device 22 antenna orientation;
k. Wireless device 22 position;
l. Wireless device 22 mobility info, e.g., wireless device 22 speed and/or the direction wireless device 22 moves;
m. Which beams that are blocked by near-field objects (e.g., human body);
n. Which panels 83 that are blocked by near-field objects (e.g., human body);
o. Which beams that are blocked by far-field moving objects (e.g., vehicles, pedestrians etc.);
p. Which panels 83 that are blocked by far-field moving objects (e.g., vehicles, pedestrians etc.);
q. The “UL-RS resource to WD beam”-mapping has been changed from previous UL-RS transmission occasion; and/or
r. “UE antenna/beam configuration ID”.

Example X17. The method of Example X1, wherein an UL-RS resource is repeated R times (where R is an integer equal to or larger than 1).

Example X18. The method of Example X17, wherein the wireless device 22 uses the same wireless device 22 beam for all R repetitions of an UL-RS resource.

Example X19. The method of any of Example X1, wherein the wireless device 22 receives a beam indication message containing an UL-RS ID.

Example X20. The method of Example X19, wherein the UL-RS ID is associated with a wireless device 22 beam according to the “UL-RS ID to WD beam”-mapping.

Example X21. The method of any one of Examples X19 and X20, wherein the wireless device 22 applies the wireless device 22 beam associated with the indicated UL-RS ID.

Example X22. The method of any one of Examples X19-X21, where the UL-RS ID contained in the beam indication message (If) is associated with an UL RS resource (wireless device 22 beam) that is different from the N UL reference signal resources (N transmitted wireless device 22 beams) configured in the UL reference signal configuration (la).

Example X23. The method of any one of Examples X1-X22, wherein the UL-RS is an SR.

Some embodiments may include one or more of the following.

Embodiment A1. A network node configured to communicate with a wireless device (WD), the network node configured to, and/or comprising a radio interface and/or comprising processing circuitry configured to:
configure an uplink, UL, reference signal, RS, UL-RS, configuration of at least one UL reference signal resource;
transmit the UL-RS configuration to the WD;
receive an association between UL-RS resources and beams of the WD; and
receive at least one UL-RS configured by the UL-RS configuration on at least one of the beams of the WD associated with the UL-RS.

Embodiment A2. The network node of Embodiment A1, wherein the network node, radio interface and/or processing circuitry are configured to receive a capability of the WD to support UL-RS data collection for beam pair link prediction by the network node.

Embodiment A3. The network node of Embodiment A2, wherein the capability includes at least one of a total number of beams per antenna panel of the WD to be used for beam pair link data collection, and a total number of beams per antenna panel of the WD to be used for beam pair link data collection.

Embodiment A4. The network node of any of Embodiments A1-A3, wherein the network node, radio interface and/or processing circuitry are configured to transmit an indication of a mapping between beams of the WD and UL-RS resources.

Embodiment A5. The network node of any of Embodiments A1-A4, wherein the network node, radio interface and/or processing circuitry are configured to receive an indication from the WD of a set of UL-RS resources used by the WD for data collection.

Embodiment B1. A method implemented in a network node configured to communicate with a wireless device, WD, the method comprising:
configuring an uplink, UL, reference signal, RS, UL-RS, configuration of at least one UL reference signal resource;
transmitting the UL-RS configuration to the WD;
receiving an association between UL-RS resources and beams of the WD; and
receiving at least one UL-RS configured by the UL-RS configuration on at least one of the beams of the WD associated with the UL-RS.

Embodiment B2. The method of Embodiment B1, further comprising receiving a capability of the WD to support UL-RS data collection for beam pair link prediction by the network node.

Embodiment B3. The method of Embodiment B2, wherein the capability includes at least one of a total number of beams per antenna panel of the WD to be used for beam pair link data collection, and a total number of beams per antenna panel of the WD to be used for beam pair link data collection.

Embodiment B4. The method of any of Embodiments B1-B3, further comprising transmitting an indication of a mapping between beams of the WD and UL-RS resources.

Embodiment B5. The method of any of Embodiments B1-B4, further comprising receiving an indication from the WD of a set of UL-RS resources used by the WD for data collection.

Embodiment C1. A wireless device (WD) configured to communicate with a network node, the WD configured to, and/or comprising a radio interface and/or processing circuitry configured to:
receive an uplink, UL, reference signal, RS, UL-RS, configuration of at least one UL reference signal resource;
determine an association between UL-RS resources and beams of the WD; and
transmit at least one UL-RS configured by the UL-RS configuration on at least one of the beams of the WD associated with the UL-RS.

Embodiment C2. The WD of Embodiment C1, wherein the WD, radio interface and/or processing circuitry is further configured to transmit a capability of the WD to support UL-RS data collection for beam pair link prediction by the network node.

Embodiment C3. The WD of Embodiment C2, wherein the capability includes at least one of a total number of beams per antenna panel of the WD to be used for beam pair link data collection, and a total number of beams per antenna panel of the WD to be used for beam pair link data collection.

Embodiment C4. The WD of any of Embodiments C1-C3, wherein the WD, radio interface and/or processing circuitry are configured to map each beam of the beams of the WD to a UL-RS resource.

Embodiment C5. The WD of Embodiment C4, wherein the mapping is according to an indication from the network node.

Embodiment C6. The WD of any of Embodiments C1-C5, wherein the WD, radio interface and/or processing circuitry are configured to indicate to the network node a set of UL-RS resources used by the WD for data collection

Embodiment D1. A method implemented in a wireless device (WD) configured to communicate with a network node, the method comprising:
receiving an uplink, UL, reference signal, RS, UL-RS, configuration of at least one UL reference signal resource;
determining an association between UL-RS resources and beams of the WD; and
transmitting at least one UL-RS configured by the UL-RS configuration on at least one of the beams of the WD associated with the UL-RS.

Embodiment D2. The method of Embodiment D1, further comprising transmitting a capability of the WD to support UL-RS data collection for beam pair link prediction by the network node.

Embodiment D3. The method of Embodiment D2, wherein the capability includes at least one of a total number of beams per antenna panel of the WD to be used for beam pair link data collection, and a total number of beams per antenna panel of the WD to be used for beam pair link data collection.

Embodiment D4. The method of any of Embodiments D1-D3, further comprising mapping each beam of the beams of the WD to a UL-RS resource.

Embodiment D5. The method of Embodiment D4, wherein the mapping is according to an indication from the network node.

Embodiment D6. The method of any of Embodiments D1-D5, further comprising indicating to the network node a set of UL-RS resources used by the WD for data collection.

Some embodiments may include one or more of the following.

Embodiment E1. A network node configured to communicate with a wireless device, the network node configured to, and/or comprising a radio interface and/or comprising processing circuitry configured to:
determine an uplink (UL) reference signal configuration indicating a mapping of a plurality of UL reference signals to a plurality of beam pair links;
configure the wireless device with the determined UL reference signal configuration;
receive, from the wireless device, a first UL reference signal of the plurality of UL reference signals on a first beam pair link of the plurality of beam pair links based on the UL reference signal configuration and the mapping;
measure a first signal quality metric of the received first UL reference signal;
predict a second signal quality metric of a second UL reference signal of the plurality of UL reference signals associated with a second beam pair link of the plurality of beam pair links based on the measured first signal quality metric;
determine a best beam pair link of the plurality of beam pair links based on the measured first signal quality metric and the predicted second signal quality metric; and
cause transmission of an indication to the wireless device indicating the determined best beam pair for the wireless device to transmit and/or receive signaling based on the mapping of the plurality of UL reference signals to the plurality of beam pair links.

Embodiment E2. The network node of Embodiment A1, wherein the predicting of the second signal quality metric is based on a machine learning (ML) model, the ML model receiving at least one input including:
the measured first signal quality metric;
positioning information associated with the wireless device;
location information associated with the wireless device; and/or
mobility information associated with the wireless device.

Embodiment E3. The network node of Embodiment A2, wherein the network node is further configured to:
train the ML model based on at least one measurement report associated with the first wireless device.

Embodiment E4. The network node of any one of Embodiments A1-A3, wherein the network node is further configured to:
receive, from the wireless device, a capability indication, the capability indication indicating at least one of:
a total number of antenna ports per beam and/or per panel;
at least one beam which may be transmitted simultaneously with at least one panel;
a mapping of wireless device beams to wireless device panels;
a beam switching time;
an antenna gain for at least one beam;
a bandwidth for at least one beam; and
a direction associated with at least one beam and/or at least one panel; and
the determining of the UL reference signal configuration being based on the received capability indication.

Embodiment F1. A method implemented in a network node, the method comprising:
determining an uplink (UL) reference signal configuration indicating a mapping of a plurality of UL reference signals to a plurality of beam pair links;
configuring the wireless device with the determined UL reference signal configuration;
receiving, from the wireless device, a first UL reference signal of the plurality of UL reference signals on a first beam pair link of the plurality of beam pair links based on the UL reference signal configuration and the mapping;
measuring a first signal quality metric of the received first UL reference signal;
predicting a second signal quality metric of a second UL reference signal of the plurality of UL reference signals associated with a second beam pair link of the plurality of beam pair links based on the measured first signal quality metric;
determining a best beam pair link of the plurality of beam pair links based on the measured first signal quality metric and the predicted second signal quality metric; and
causing transmission of an indication to the wireless device indicating the determined best beam pair for the wireless device to transmit and/or receive signaling based on the mapping of the plurality of UL reference signals to the plurality of beam pair links.

Embodiment F2. The method of Embodiment B1, wherein the predicting of the second signal quality metric is based on a machine learning (ML) model, the ML model receiving at least one input including:
the measured first signal quality metric;
positioning information associated with the wireless device;
location information associated with the wireless device; and/or
mobility information associated with the wireless device.

Embodiment F3. The method of Embodiment B2, further comprising:
training the ML model based on at least one measurement report associated with the first wireless device.

Embodiment F4. The method of any one of Embodiments B1-B3, further comprising:
receiving, from the wireless device, a capability indication, the capability indication indicating at least one of:
   a total number of antenna ports per beam and/or per panel;
   at least one beam which may be transmitted simultaneously with at least one panel;
   a mapping of wireless device beams to wireless device panels;
   a beam switching time;
   an antenna gain for at least one beam;
   a bandwidth for at least one beam; and
   a direction associated with at least one beam and/or at least one panel; and
the determining of the UL reference signal configuration being based on the received capability indication.

Embodiment G1. A wireless device configured to communicate with a network node, the wireless device configured to, and/or comprising a radio interface and/or processing circuitry configured to:
receive, from the network node, an uplink (UL) reference signal configuration indicating a mapping of a plurality of UL reference signals to a plurality of beam pair links;
determine a first UL reference signal of the plurality of UL reference signals associated with a first beam pair link of the plurality of beam pair links based on the UL reference signal configuration and the mapping
cause transmission, to the network node, of the first UL reference signal on the first beam pair link;
receive, from the network node, an indication indicating a determined best beam pair, the best beam pair being determined based on a measured first signal quality metric of the first UL reference signal and a predicted second signal quality metric of a second UL reference signal; and
at least one of transmit signaling to and receive signaling from the network node based on the determined best beam pair.

Embodiment G2. The wireless device of Embodiment C1, wherein the predicted second signal quality metric is determined based on a machine learning (ML) model, the ML model receiving at least one input including:
the measured first signal quality metric;
positioning information associated with the wireless device;
location information associated with the wireless device; and/or
mobility information associated with the wireless device.

Embodiment G3. The wireless device of Embodiment C2, wherein the ML model is trained based on at least one measurement report associated with the first wireless device.

Embodiment G4. The wireless device of any one of Embodiments C1-C3, wherein the wireless device is further configured to:
determine a capability indication, the capability indication indicating at least one of:
   a total number of antenna ports per beam and/or per panel;
   at least one beam which may be transmitted simultaneously with at least one panel;
   a mapping of wireless device beams to wireless device panels;
   a beam switching time;
   an antenna gain for at least one beam;
   a bandwidth for at least one beam; and
   a direction associated with at least one beam and/or at least one panel; and
cause transmission of the capability indication to the network node, the receiving of the UL reference signal configuration being based on the transmitted capability indication.

Embodiment H1. A method implemented in a wireless device (WD), the method comprising: receive, from the network node, an uplink (UL) reference signal configuration indicating a mapping of a plurality of UL reference signals to a plurality of beam pair links;
determining a first UL reference signal of the plurality of UL reference signals associated with a first beam pair link of the plurality of beam pair links based on the UL reference signal configuration and the mapping
causing transmission, to the network node, of the first UL reference signal on the first beam pair link;
receiving, from the network node, an indication indicating a determined best beam pair, the best beam pair being determined based on a measured first signal quality metric of the first UL reference signal and a predicted second signal quality metric of a second UL reference signal; and
at least one of transmitting signaling to and receiving signaling from the network node based on the determined best beam pair.

Embodiment H2. The method of Embodiment D1, wherein the predicted second signal quality metric is determined based on a machine learning (ML) model, the ML model receiving at least one input including:
the measured first signal quality metric;
positioning information associated with the wireless device;
location information associated with the wireless device; and/or
mobility information associated with the wireless device.

Embodiment H3. The method of Embodiment D2, wherein the ML model is trained based on at least one measurement report associated with the first wireless device.

Embodiment H4. The method of any one of Embodiments D1-D3, further comprising:
determining a capability indication, the capability indication indicating at least one of:
   a total number of antenna ports per beam and/or per panel;
   at least one beam which may be transmitted simultaneously with at least one panel;
   a mapping of wireless device beams to wireless device panels;
   a beam switching time;
   an antenna gain for at least one beam;
   a bandwidth for at least one beam; and
   a direction associated with at least one beam and/or at least one panel; and
causing transmission of the capability indication to the network node, the receiving of the UL reference signal configuration being based on the transmitted capability indication.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
3GPP 3rd Generation Partnership Project
5G Fifth Generation
ACK Acknowledgement
AI Artificial Intelligence
AoA Angle of Arrival
CORESET Control Resource Set
CSI Channel State Information
CSI-RS CSI Reference Signal
DCI Downlink Control Information
DoA Direction of Arrival
DL Downlink
DMRS Downlink Demodulation Reference Signals
FDD Frequency-Division Duplex
FR2 Frequency Range 2
HARQ Hybrid Automatic Repeat Request
ID identity
gNB gNodeB
MAC Medium Access Control
MAC-CE MAC Control Element
ML Machine Learning
NR New Radio
NW Network
OFDM Orthogonal Frequency Division Multiplexing
PBCH Physical Broadcast Channel
PCI Physical Cell Identity
PDCCH Physical Downlink Control Channel
PDSCH Physical Downlink Shared Channel
PRB Physical Resource Block
QCL Quasi co-located
RB Resource Block
RRC Radio Resource Control
RSRP Reference Signal Strength Indicator
RSRQ Reference Signal Received Quality
RSSI Received Signal Strength Indicator
RL Reinforcement Learning
RS Reference Signal
Rx Receiver
SCS Subcarrier Spacing
SINR Signal to Interference plus Noise Ratio
SRS Sounding Reference Signal
SSB Synchronization Signal Block
TB Transport Block
TDD Time-Division Duplex
TCI Transmission configuration indication
TRP Transmission/Reception Point
Tx Transmitter
UE User Equipment
UL Uplink
WD Wireless Device

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-50. (canceled)

51. A method in a wireless device, WD, configured to communicate with a network node, the method comprising:
determining a mapping between M beams corresponding to M spatial filters of the WD and M beam identifications, IDs, M being an integer greater than zero;
receiving a configuration of uplink reference signals; and
transmitting N uplink reference signals of the received configuration in N beams of the M beams, N being an integer not greater than M.

52. The method of claim 51, wherein the N beams used to transmit the N uplink reference signals are indicated to the WD by indicating N of M beam IDs.

53. The method of claim 51, wherein a beam ID of the M beam IDs is an uplink reference signal ID.

54. The method of claim 51, further comprising receiving a selected beam ID indicating a beam of the WD selected by the network node from the M beams.

55. The method of claim 54, wherein the selected beam ID is based at least in part on measurements on the N uplink reference signals.

56. The method of claim 51, further comprising storing an uplink reference signal ID for each of the N uplink reference signals.

57. The method of claim 51, wherein transmitting the N uplink reference signals is in response to a trigger received from the network node.

58. The method of claim 51, further comprising transmitting an antenna configuration ID and a mapping between the antenna configuration ID and a beam ID.

59. The method of claim 51, further comprising transmitting an indication of at least one of a number of antenna ports per beam and a number of antenna ports per antenna panel.

60. The method of claim 51, further comprising transmitting a mapping of beams to antenna panels of the WD.

61. The method of claim 51, further comprising transmitting an indication of beams to be transmitted simultaneously by the WD.

62. The method of claim 61, further comprising associating uplink reference signal resources to different antenna panels of the WD.

63. The method of claim 51, further comprising transmitting assistance information associated with transmission of the N beams, the assistance information including at least one of an antenna orientation, a WD position, velocity and direction, and non-line-of-sight information.

64. A wireless device, WD, configured to communicate with a network node, the WD comprising:
processing circuitry configured to determine a mapping between M beams corresponding to M spatial filters of the WD and M beam identifications, IDs, M being an integer greater than zero; and
a radio interface in communication with the processing circuitry and configured to:
receive a configuration of uplink reference signals; and
transmit N uplink reference signals of the received configuration in N beams, N being an integer not greater than M.

65. The WD of claim 64, wherein the N beams used to transmit the N uplink reference signals are indicated to the WD by indicating N of M beam IDs.

66. A method in a network node configured to communicate with a wireless device, WD, the method comprising:
receiving M uplink reference signals transmitted by the WD in M respective beams, M being a integer greater than zero;
performing a measurement on each of the received M uplink reference signals; and
selecting an uplink reference signal out of the M uplink reference signals based at least in part on an artificial intelligence, AI, model receiving the measurements as inputs.

67. The method of claim 66, further comprising sending an uplink reference signal identification, ID, to the WD, the uplink reference signal ID indicating the selected uplink reference signal.

68. The method of claim 66, further comprising configuring the WD with a mapping between N beams and N beam identifications, IDs.

69. The method of claim 66, further comprising receiving from the WD an antenna configuration ID and a mapping between the antenna configuration ID and a beam ID.

70. The method of claim 66, further comprising receiving from the WD an indication of at least one of a number of antenna ports per beam and a number antenna ports per antenna panel.
